(19) United States
(12) Patent Application Publication
(10) Pub. No.: US 2011/0294081 A1
(43) Pub. Date: Dec. 1, 2011

(54) Transforming container candles and uses thereof

(76) Inventors: Margaret Jean McLaren, Miami, FL (US); George Inana, Miami, FL (US)

(21) Appl. No.: 13/068,247

(22) Filed: May 7, 2011

Related U.S. Application Data
(60) Provisional application No. 61/396,475, filed on May 27, 2010.

(51) Int. Cl. F23D 3/16; C11C 5/00

(52) U.S. Cl. 431/291

(57) ABSTRACT

The invention provides transforming container candles that, during burning, exhibit striking color-changing and pattern-forming characteristics. A color-changing transforming container candle may comprise at least a first and a second layer, column or core of wax of different colors. During burning of the candle, the colored wax components become liquefied and intermixed, ultimately transforming into a single layer of wax of a final color differing from that of the original wax layers. Color-changing candles configured in particular color combinations and arrangements of wax components are useful for color therapy of the human energy system, including the chakras and meridians. Transforming candles can be “sentimented” with benevolent intentions and energies (such as the desire for healing, world peace, etc.) by a method that includes the practice of mindfulness by a chandler during the production of the candle.

### CROSS REFERENCE TO RELATED APPLICATIONS

The present application claims the benefit of priority of U.S. Provisional Patent Application No. 61/396,475, filed May 27, 2010, entitled Transforming Container Candles and Uses Thereof the disclosure of which is hereby incorporated by reference in its entirety.

### FIELD OF THE INVENTION

The invention generally relates to candles and methods for producing candles. More specifically, it relates to novel methods for producing dynamic color-changing and pattern-forming transforming container candles comprising liquid wax, and to candles produced by these methods.

### BACKGROUND OF THE INVENTION

Ever since the gift of fire was bestowed upon humanity, people have had an abiding fascination with flames. For centuries, candles in various forms were used as the sole source of portable lighting in darkness. Despite the prediction by Thomas Edison that the invention of the electric light bulb would supplant the candle industry, in modern times candles continue to be used in large numbers around the world, both for ceremonial and decorative purposes. The burning of a candle has an enduring ability to captivate humans with its unique beauty and mystique.

Many forms of decorative candles are available to today's consumers, in a wide variety of sizes and shapes. The term “container candle” is used in the candle-making industry to refer to any candle comprising a container, the contained wax and a wick. Container candles are made in an endless variety of containers, such as jars, vases, glasses, and the like.

In recent years, a particular form of small container candle has gained widespread popularity, viz., the so-called “tealight” or “tealite” (“TL”) candle. The container of a tealight candle is a cylinder, typically made of aluminum or clear plastic, having a fairly standard diameter of about 38-40 mm, and a depth of about 19 mm. The wick is supported by a metal “tab” having a flat, rounded base ranging from about 15-20 mm in diameter, from which extends a thin cylindrical metal collar of variable length (typically from 3-9 mm) that surrounds the wick and secures the wick to the base of the tab. In the finished tealight candle, the solidified wax fills the container to close to the top of the container, and the unlit wick is seen to extend from about 10-20 mm above the upper surface of the solid wax.

As is well known, candle waxes often contain dyes or pigments that are added to impart a desired color to the wax, increasing the visual and decorative appeal of the solid candle, as well as enhancing the beauty of the candle during burning. Unexpectedly, in the tealight candle industry, it is very common for manufacturers to add both colored dyes and particular fragrances to the candle waxes, in order to create a colored tealight candle product that appeals to both the visual and the olfactory senses of the user. In fact, it is very unusual to find a tealight candle in any color other than white or ivory that does not also contain an added fragrance.

Whereas the combination of color and fragrance chosen by a candle manufacturer may be appealing to those who happen to enjoy the particular combination of color and scent, there are many individuals, particularly men, who might prefer the particular color but not the chosen scent, or vice versa, or even a completely unscented colored candle. In particular, those who suffer from allergies are inclined to stay away from scented candles altogether.

Importantly, the inclusion of scent in colored tealight candle waxes in most cases precludes the possibility of burning scented tealight candles of more than one color together in a grouping, due to the undesirable clashing of incompatible scents.

Candle waxes, like other colored artistic media, can be created in an infinite variety of colors. Tealight candles, given their small size, are particularly suited to combining and burning in groups. Given their beauty and relatively inexpensive cost compared with larger candles, it would be very desirable to have colored tealight candles that could be combined in unlimited color groupings. It would be particularly desirable if such candles were designed to be experienced as dynamic works of art, capable of transforming in color and form before the viewer's eyes, under the power of the candle's flame.

### SUMMARY OF THE INVENTION

The present invention provides a transforming container candle with artistic and visual appeal. The candle is configured to undergo a series of physical transformations, with corresponding color changes or other visual transformations such as pattern-forming, so as to present an ever-changing visual display during the burning of the candle.

Accordingly, and in one aspect, the invention provides a color-changing transforming container candle. The candle includes a candle container, a wick, and at least a first layer and a second layer of a colored wax positioned within the container and in contact with a wick.

One preferred embodiment of a color-changing transforming candle in accordance with the present invention is a bilayered candle comprising a first and second layer of wax of a first and a second color, respectively. Upon burning, the colored layers of wax become liquefied and their dyes are released. The waxes are intermixed and ultimately transformed into a single layer of a third color that differs from that of either the first or the second colored wax layer.

A particularly preferred embodiment of a transforming color-changing candle in accordance with the present invention is a multi-layered candle in which the colored wax layers are arranged in a spectrum of colors, creating a rainbow effect.

In the solid state, the wax layers of a transforming color-changing candle are preferably distinguishable from one another by their color.

In one particularly preferred embodiment of a multi-layered rainbow candle in accordance with the present invention, the colored wax layers are positioned, from base to top, in a tealight candle container in the order observed in a rainbow, i.e., in the order: Red, Orange, Yellow, Green, Blue, Indigo, and Violet.

In another preferred embodiment of the aforementioned rainbow candle, the colors are layered in the reverse order (i.e., with Violet wax on the bottom and Red wax on the top).

In one preferred embodiment of a multi-layered color-transforming rainbow candle in accordance with the invention, upon transformation, the final color of the mixed, fully liquefied wax is Magenta.

To facilitate the color change, a color-changing transforming candle in accordance with the invention is configured such that each of the wax layers becomes liquid during the burning of the candle, with release of its dye. Successive wax layers, from top to bottom, become intermixed, ultimately forming a single layer of a wax mixture of a final color that is different from the color of any of the individual wax layers. All-natural soy-based waxes and soy blends with melting points in the range of 110° F. to 130° F. are particularly suitable for this purpose.

Certain preferred embodiments of color-changing transforming container candles in accordance with the present invention are useful as “healing lights” for color therapy of components of the human energy system, which includes the aura, chakras, and meridians.

One preferred embodiment of a healing light candle is a bilayered color-changing transforming container candle useful for modulating and balancing the energies of the meridians of the human energy system.

Another preferred embodiment of a healing light candle is a bilayered color-changing transforming container candle useful for balancing and linking the energies of two or more chakras of the human energy system.

Yet another preferred embodiment of a transforming container candle in accordance with the present invention is a “sentimented” candle or “prayer in a candle” in which benevolent energetic sentiments and intentions of the chandler (for example for peace, healing, compassion, understanding, and so on), are incorporated into the wax of the candle by a chandler practicing mindfulness in an atmosphere of serenity and reverence while creating and handling the candle.

Yet another embodiment of a transforming container candle in accordance with the present invention is a pattern-forming transforming container candle. A pattern-forming transforming container candle includes a candle container, a wick, and at least a first layer of a colored or uncolored wax, and at least a second layer, or a wax inclusion within the first wax layer, of a second colored or uncolored wax comprising particles that are insoluble in wax. The first and second waxes are contained within the container and positioned to surround the wick. The candle is configured such that, upon burning of the wick, each of the first and second waxes becomes liquid, and the particles are released from the liquefied second wax and can float and congregate on the surface of the molten candle wax, forming dynamic patterns as the candle burns.

In one preferred embodiment of a pattern-forming transforming container candle in accordance with the present invention, at least one layer of the candle wax comprises metallic particles that are insoluble in wax. Upon burning of the candle, the metallic particles circulate through the wick and float on the surface of the molten wax, forming continuously-changing patterns of metallic streaks and swirls (“gilding”) as the candle burns.

Experiments described herein provide evidence that observing a lighted, colored (“liquid light”) candle of the present invention can rapidly and reversibly change at least one color in the aura (“biofield”) of a human subject. This finding may have important implications for the emerging alternative energy medicine field of color-based therapy. Accordingly, and in another aspect, the invention further provides a method for self-administering color healing to the energy system of a human subject. The method comprises observing a lighted colored “liquid light” candle made in accordance with the present invention, for a period of time sufficient to change at least one color in the aura, or the energy level in at least one chakra or meridian in the subject.

These and other aspects of the invention are more fully disclosed in the accompanying detailed description and drawings.

### BRIEF DESCRIPTION OF THE DRAWINGS

FIG. 1A-F includes a series of photographs depicting changes in the appearance of a color-changing transforming container candle, in accordance with an embodiment of the present invention. The depicted embodiment is configured as a Yellow-over-Blue bilayered tealight candle. The series of visual transformations, including color changes, undergone by the candle during burning, cooling, and subsequent re-burning are described in detail in the specification.

FIG. 2A-F includes a series of photographs depicting changes in the appearance at various times before, during, and after the burning of a seven-layered “rainbow” embodiment of a color-transforming container candle, in accordance with the present invention.

FIG. 3A-F includes a series of photographs depicting changes in the appearance during the burning of a pattern-forming transforming container candle in accordance with an embodiment of the present invention. In the embodiments shown, the candle wax comprises metallic gold or silver particles that float on the surface of the liquid wax, forming intricate, ever-changing gilded patterns as the wax circulates through the burning wick and drops onto the surface of the candle.

FIG. 4A-D includes a series of four colored computer-generated images, shown in black-and-white, representing readouts of a real-time aura-chakra display system for measuring parameters of the human energy system. The colors of the aura and energy levels in the chakras are seen to change dramatically in a subject, upon observation of colored molten wax (“liquid light”) in burning candles made in accordance with an embodiment of the present invention.

FIG. 5A-D includes a series of photographs showing bilayered color-transforming tealight candles for modulating and balancing the energies of the meridians of the human energy system. The particular embodiments shown in parts A-D of the figure are configured, respectively, in color combinations suitable for modulating (either increasing or decreasing) and balancing the energies in the Gallbladder, Liver, Lung, and Large Intestine meridians.

### DETAILED DESCRIPTION OF THE INVENTION

Definitions:

A “wax candle” refers to any combination of a wick and a combustible wax that liquefies and burns upon lighting of the wick. Waxes suitable for candle-making are known in the art and include, inter alia, beeswax, petroleum-based waxes such as paraffin, and waxes made from plants such as soy, palm, and the like.

A “container candle” refers to a wax candle that includes a container. A container candle is made by providing a desired container with a suitable wick and filling the container with molten wax. The molten wax hardens around the wick and solidifies within the container, to form a contained candle. As used herein, the term “container candle” refers to a candle that includes the container in which the wax is contained. Typical commercially available container candles include candles marketed as “jar candles” and “tealight candles;” however a container candle, as the term is used herein, can be made in any container of appropriate size, shape and construction to safely contain molten wax.

A “containerless candle” is a candle made of wax of sufficient rigidity and other appropriate qualities so as to be free-standing when burned. A containerless candle does not include a container. Well-known examples of containerless candles include tapers, votives, and pillars of various sizes and shapes. To make a containerless candle, molten wax is poured into a suitable mold fitted with a wick. Upon hardening of the wax, the candle is subsequently released from the mold.

A “tealight candle” is a type of small container candle supplied in a shallow cylindrical container generally of standard dimensions, for example, approximately 35-40 mm in diameter and 15-20 mm deep. Tealight containers or “cups” are typically constructed from thin sheets of metals such as aluminum or alloys, or, preferably, from clear or transparent heat-resistant plastic such as polystyrene.

A “color-changing” candle, as the term is used herein, is meant to refer to a candle that during burning, changes the color of its wax from a first to at least a second color as a result of flame-driven mixing of two or more colored waxes constituting the candle. Thus, the term “color-changing” is not intended to refer to the mere difference in the color of a candle wax as it appears in its solid and liquid states (e.g., a wax that appears Pale Violet when solid and Deep Violet when molten). Rather, the term “color-changing” is meant to refer to the change in color, for example, of a bilayered candle having solid layers of Blue and Yellow wax that, after transformation by burning, comprises a monolayer of mixed wax having an essentially uniform Green color.

As used herein, the term “multi-layered” as applied to a container candle, refers to a candle comprising at least two layers of wax having distinguishable properties such as color, inclusion of particulates, etc., as described herein. Accordingly, a multi-layered container candle may comprise any number of layers greater than one, and typically in the range of 2-10 for a typical tealight candle of standard dimensions as defined herein.

A “pattern-forming” candle, as the term is used herein, is meant to refer to a candle that exhibits a dynamic, changing pattern on the surface of the molten wax during burning of the candle wherein the pattern is created by a particulate component in the wax. Pattern-forming candles of the invention are produced using one or more waxes that include a wax-insoluble particulate element such as a metallic dye that is released from the wax during burning of the candle. The particulate component remains on the surface of the candle, creating moving patterns that are distinct from the movement of the melted wax.

A “wax inclusion within a first wax layer,” as the term is used herein, is meant to refer to a portion of wax that is embedded within, or otherwise associated with, a first layer of wax other than as a layer, and that differs in some way from the first layer (such as in color, wax type, or inclusion of particulate matter). For example, a wax inclusion containing a metallic dye may be made by forming a bolus or column of such wax around a wick and allowing it to solidify as an inclusion. The wick with the attached metallic wax inclusion can then be immersed in the molten wax of a first wax layer during candlemaking, resulting in a candle having the metallic wax as an embedded inclusion or “core” (even a fully hidden one) which will become molten and released during burning of the candle.

“Gilding” or “gilt,” as the term is used herein, refers to a metallic particulate component that is included in the wax of a candle to impart a metallic sheen. As used herein, the term “gilt” is not meant to refer to a purely decorative finish that is sometimes applied to an outer surface of a candle, i.e., to a surface that is not intended to come into contact with the wick, or with wax that becomes molten upon lighting the candle. Rather, the metallic particles that contribute the gilding feature in accordance with the present invention are incorporated into the wax that comprises that portion of the candle wax that is burned during use. The particles of metallic pigment comprising the gilt may be situated (“floating”) upon the fluid wax at the surface of a burning container candle, or they may be suspended within the wax of a container candle. Typically, the gilding may appear as a usual metallic color such as gold, silver, or copper, etc.; however, the term gilding is intended to be unlimited, and can include any suitable metallic element of any color.

“Gilded candle wax,” as the term is used herein, refers to any candle wax to which wax-insoluble metallic particulates have been added. Gilding of wax is achieved by adding a suitable metallic element such as a metallic dye directly to molten wax, or alternatively by adding to molten wax a commercially prepared wax product that includes a metallic dye of the desired appearance. The terms “gilded wax candle” or “gilded wax layer” refer to candles, or portions thereof, that include gilded candle wax as defined herein.

“Gilded pattern” refers to any visible distribution of a metallic element (particle) that is incorporated into the wax of a candle, and is created spontaneously during the burning of the candle. For example, a gilded pattern may form spontaneously on the surface of the lit candle as metallic particles that are suspended in the gilded candle wax are drawn into and released from the wick, and subsequently separate from the molten wax and float, congregating together in intricate gilded patterns on the surface of the molten wax, as further described infra.

The term “gilded pattern” is also meant to encompass a pattern that is formed on the inside surface of the container of a container candle comprising gilded wax as the candle burns. For example, one such type of gilded pattern is a layer of metallic foil that is formed during the burning of a gilded candle and is gradually deposited on the inner surface of the candle container. In this process (termed herein “self-gilding”), metallic dye elements floating on the surface of the molten wax are seen to apply themselves in a thin metallic sheet (a “foil” or “leaf” layer) on the inner surface of the container above the level of the wax as the volume of molten wax gradually decreases, and the level of the molten wax front slowly recedes.

### Color-Changing Transforming Container Candles

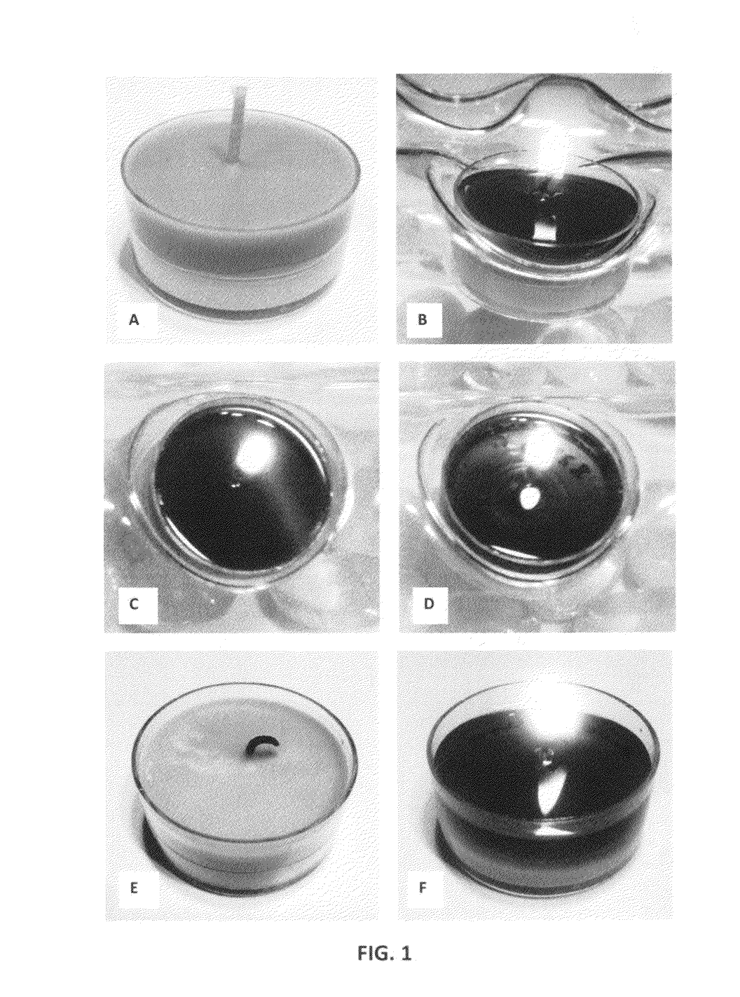

As discussed above, in one aspect the invention provides a color-changing transforming container candle comprising a candle container, a wick, and at least a first layer and a second layer of a colored wax contained within the container and surrounding the wick. In a color-changing candle in accordance with the present invention, the wax layers in the solid state are distinguishable from one another by their color. The candle is configured, upon burning of the wick, such that each of the colored wax layers becomes liquefied, and the layers become intermixed and ultimately transformed into a layer of a mixed wax having a third color that is different from the color of either of the first or second wax layers. FIG. 1A-F illustrates the color changes that occur during burning of an embodiment of the invention configured as a bilayered color-changing tealight candle. The details of the observed color changes are described in Example 2 below.

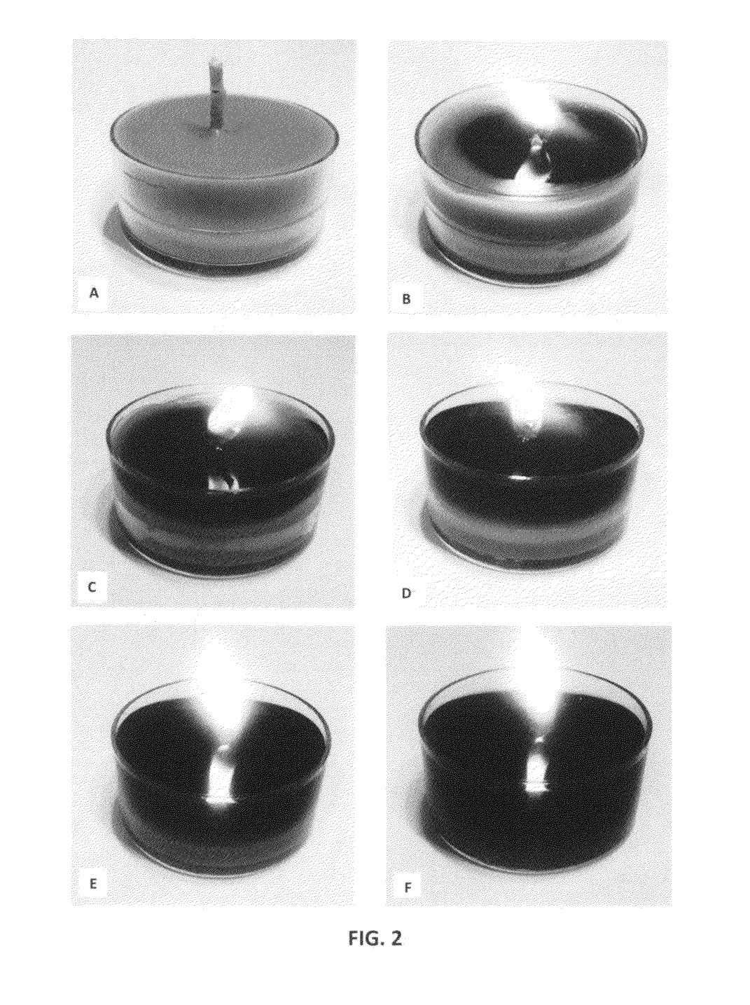

One particularly preferred but non-limiting embodiment of a color-changing transforming container candle of the invention is a multilayered “rainbow” candle comprising seven colored wax layers, each having one color of the rainbow (i.e., Red, Orange, Yellow, Green, Blue, Indigo, or Violet). In this embodiment, the final color that is produced upon mixing of the seven colored waxes is Magenta. Some of the color changes observed during burning of this embodiment of a transforming color-changing container candle are shown in FIG. 2A-F and described in detail in Example 3, infra.

A transforming color-changing container candle in accordance with the present invention is made by combining at least two separate layers of molten wax, each having a different color, in a suitable container. Many containers suitable for producing container candles, such as various types of jars and tealight candle containers, are well known in the art and readily available from craft stores and online suppliers of candlemaking materials.

To achieve a sharp interface between the colored wax layers, each layer of molten wax is allowed to cool and solidify in the container before the next molten layer is poured over the layer below. Typically, in the case of tealight container candles, a tabbed wick is placed in the tealight container before, or shortly after, the first layer of wax is poured, while the wax is still fully or partly molten. Cooling and solidification of each wax layer can be performed at room temperature. Alternatively, the time for the cooling and solidifying process can be shortened by placing the containers with molten wax in a refrigerator.

Alternatively, in some applications, wax layers to be combined in a multi-layered color transforming candle in accordance with the invention can be made separately in a mold that includes a hole in the center for later insertion of the wick. In this case, individual colored wax layers, once solidified and released from the molds, can be assembled, the wick can be inserted through the aligned holes in the wax layers, and the multilayered assembly can be placed inside a candle container such as a tealight container.

As discussed, the burning of a color-changing transforming candle in accordance with the present invention results in the transformation of the color of the candle wax into a new color that differs from that of any of the original layers of wax in the candle. In order to produce the visual effects that characterize a color-transforming candle in accordance with the present invention, the candle wax must be in a dynamic state during the burning of the candle. Without intending to be bound by any particular theory, the individual layers of candle wax must become molten and sufficiently free to circulate within the wick and the container to facilitate mixing of the dyes and waxes of the other colored wax layers, under the power of capillary action or other forces generated by the burning wick.

To this end, an appropriate combination of container, wick size and candle wax is selected that has the desired characteristic of the wax becoming fully molten after the wick has been lit. In some applications, it may be preferred that the wax will become molten after the candle has been burning for a relatively short duration of its lifetime, such as during the first 10-25% of the total burn time. For example, for a soy wax tealight candle with a total burn duration of between about 5 and 8 hours, it may be desirable that from about 30 minutes to one hour after the lighting of the wick, all of the wax in the candle will become molten and thoroughly mixed. In other cases, it may be preferred to prolong or shorten the time of mixing of the colors, e.g., by adjusting the wick size, or using a wax of a higher or lower melting point.

Additionally, the duration of the time for liquefication of a layer of wax of a given color (and hence for the appearance of a color change in a multi-layered candle) can be altered by adjusting the volume of colored wax utilized to create the layer. As a non-limiting example, a bilayer candle made with two colors of wax (for example Blue and Yellow) can be poured in several configurations, only two of which are described for purposes of illustration. Such a candle can be made, e.g., in Configuration 1—i.e., with a first (bottom, lower) Blue layer comprising a volume of liquid wax that fills three-quarters of the container and with a second (upper, top) Yellow layer comprising a volume that fills the remaining one-quarter of the container. Alternatively, the same candle can be made in Configuration 2—i.e., with a bottom Blue layer filling only one-quarter of the container volume and an upper Yellow layer filling the remaining three-quarters of the container. In the two cases, the time of first appearance of the color change is different, as it is viewed through the molten top Yellow layer of the candle after lighting the wick. Container candles become molten from the top down. In the above illustration of two tealight candles (“Candle 1” and “Candle 2”), made using the same Blue and Yellow soy waxes, but configured as described in Configuration 1 and 2 respectively, the timing of the color change of the upper wax (as appreciable by the human eye) will appear to be sooner in Candle 1 than in Candle 2.

In fact, the timing of the color changes is quite reproducible among a group of candles made in a particular bilayered or multilayered configuration. Accordingly, the time of a color change in a color-changing transforming container candle in accordance with the present invention can be used as a subtle means of keeping track of the passage of time. Although clearly not as accurate as a timepiece, such a candle can be useful as a timekeeper in certain situations. For example, a bilayered or multilayered candle that is configured to first change color 15 minutes after lighting the wick could be useful at the dinner table, for example as a reminder to someone who is dieting, that they have been eating for 15 minutes. The visual cue from the candle, when it changes color noticeably, is a suggestion to the diner that it is time to stop eating! Thus the candle can be viewed as an “eating light” or “eating coach” that supports the diner in his or her efforts to control food consumption. The color-changing candle as a timer can also find utility in many other situations, such as in business and personal meetings in which there is a need to keep track of time without an obvious reference to a watch or clock, or in situations in which electrical power is not available and there is a need to time an activity.

Suitable waxes can be selected from among a wide variety of commercially available natural or synthetic candle waxes. Particularly preferred waxes are so-called “all-natural” waxes such as vegetable waxes made from soy or soy blends, which have melting points in the range of about 110-130° F. Advantageously, such waxes are ecologically friendly (“green”), especially if organically grown, and exhibit several desirable qualities for candlemaking including slow burn rate, lack of aroma, and markedly clean and soot-free burning, as compared with petroleum (paraffin)-based waxes. Soy waxes suitable for tealight candles in accordance with the present invention are produced by several manufacturers in the United States, including Nature's Gift International (Knoxville, Tenn.) and Cargill Incorporated, (Minneapolis, Minn.).

Suitable wicks can be selected from a large variety of available cotton and synthetic wicks, which can be purchased either in rolls of wicking material, or in precut lengths, in some cases in a convenient “pre-tabbed” format in which the wick is already assembled with an attached metal base, ready for use in candlemaking. Well known manufacturers of wicks include Technical Braiding (Nettetal, Germany), Wedo (Nettetal, Germany), and Atkins & Pearce (Covington, Ky.).

Many different types of dyes and other coloring agents, both in liquid and solid formats (blocks, chunks, diamond and other shapes, flakes, etc.), are available for adding color to candle waxes, and are well known in the art. Many of the above-mentioned materials and supplies needed for candlemaking, including clear plastic (e.g., polystyrene) tealight candle containers, are available to chandlers through a numerous mail order resellers, (for example, CandleChem Co. Inc., Brockton, Mass.), many of whom offer the products in online stores.

### Pattern-Forming Transforming Container Candles

In another aspect, the invention provides a pattern-forming transforming container candle comprising a candle container, a wick, and at least a first layer of a colored or uncolored wax, and at least a second layer, or a wax inclusion within the first wax layer, of a second colored or uncolored wax comprising particles that are insoluble in wax. The first and second waxes are contained within the container of the candle and surround the wick. The candle is configured such that, upon burning of the wick, the waxes becomes liquefied, and the particles are released from the second wax layer or inclusion and can float and congregate on the surface of the molten candle wax, forming dynamic patterns as the candle burns.

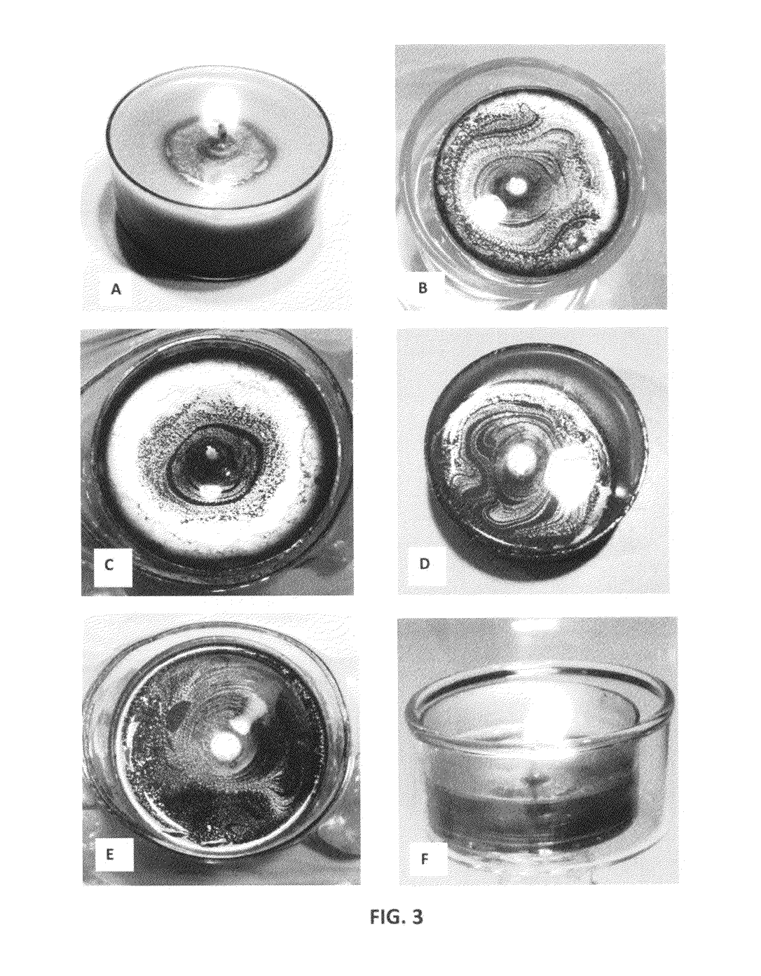

In some particularly preferred embodiments of a pattern-forming container candle in accordance with the present invention, the wax-insoluble component is a metallic particle. The patterns that form on the surface of the pattern-forming candles after the particles are released from the solid wax are displayed as attractive intricate metallic (“gilded”) patterns that appear to float and “dance” on the surface of the molten wax as the candle burns. FIG. 3A-F illustrates the appearance of gilded patterns created on the surfaces during the burning of six different metallic pattern-forming container candles in accordance with the present invention. These gilded patterns, as well as methods of production of pattern-forming container candles are more fully described in Examples 4 and 5, infra.

Additional particulars of methods of making and testing various embodiments of transforming container candles in accordance with the present invention are described in the Examples that follow.

### Uses of Transforming Container Candles

Candles have the well-established utility of providing lighting without the need for electrical power. Additionally, candles have long been admired for their appearance and beauty, which can help to establish a particular atmosphere in a physical environment (e.g., an atmosphere of reverence, or one of celebration, or of elegance). Gazing at one or more burning candles can also promote a desired psychological state in a user, such as a sense of calm and relaxation, peace, or a sense of awe.

In addition to these much-admired qualities of candles, the transforming candles of the present invention further provide the novel advantage of being able to stimulate the imagination and curiosity of the viewer. By presenting the observer with an ongoing display of transforming colors, or an ever-changing gilded pattern of attractive metallic particles gracefully moving on the surface of the candles, these “liquid light” candles have the effect of captivating the attention and mesmerizing the viewer. Prolonged visualization of these candles has been found to be conducive to very deep relaxation, transporting the viewer from a world of ordinary cares to a state of meditation and peaceful thoughts.

It is anticipated that at least certain embodiments of color-changing transforming container candles in accordance with the present invention will find utility in alternative medical practices utilizing therapeutic strategies involving “color healing,” in which exposure of a subject to one or more colors of light is indicated. As discussed in more detail in Example 6 infra, there is a school of thought in the field of mind-body medicine that promotes the use of various colors to balance and enhance the human energy system for purposes of maintaining wellness and healing.

Objective tests described herein were designed to evaluate whether or not observing colored tealight candles made in accordance with the present invention could alter the colors seen in the human aura (an energetic field surrounding the human body, also known as the “biofield”). In these studies it was determined that viewing a burning Red soy wax tealight candle for five minutes had the result of rapidly and reversibly adding brilliant Red to the aura. Similarly, viewing a burning Yellow soy tealight candle for five minutes rapidly and reversibly added bright Yellow to the aura (see Example 6). Although the physiological, emotional, and psychological implications of these findings are not fully understood at the present time, it is clear that the “liquid light” viewed in the burning colored candles provided a very effective tool for achieving rapid color changes in the aura, which presumably affected the entire energy system.

From these findings it is further anticipated that viewing a bilayered or multi-layered candle comprising wax layers of several different colors, or even a 7-layered candle incorporating the full spectrum of rainbow colors, would have even more profound effects on the aura-chakra system than viewing a candle of a particular color.

In several aspects, the invention provides a color-transforming candle for balancing the energy field of a human subject. It is believed by leaders in the field of alternative medicine known as “energy medicine” that certain colors are useful for balancing the energies of individual meridians, or energetic pathways in the human body, as described in Traditional Chinese Medicine (TCM). According to Donna Eden and David Feinstein, Ph.D., authors of best-selling Energy Medicine. Balancing Your Body's Energies for Optimal Health, Joy, and Vitality, (Penguin Books, New York, 2008), the energies associated with each meridian can be either stimulated or reduced by treatment of an acupuncture/acupressure point or chakra with light of a particular color. These authors teach that in addition to the well known seven chakras (spiraling energy centers) aligned along the spine, there are many secondary chakras in the human body, including chakras in the eyes. The use of color therapy through the eyes is further described in great detail in the treatise Light. Medicine of the Future, by Jacob Lieberman, O.D., Ph.D. (Bear & Co., Rochester, Vt., 1991).

A summary of the colors of light useful for treatment and balancing of the energies of each meridian is presented in Table 2 of Example 7. Based on this teaching, color-transforming candles for color therapy of the meridians are provided in combinations of colors useful for balancing the energy within each meridian, by either raising it or lowering it. The candles are configured to support and balance the meridian energies through visualization of the blending of “liquid light” of the appropriate color, which is created during the blending of two appropriately-colored waxes during the burning of the candle. Understanding by the end user of the intended purpose of the color balancing can be achieved by providing instructions for use with the candle, or providing teaching materials online, for example in a website used for marketing such candles. Simple illustrations of the anatomical location on the body of the meridian pathways and useful acupuncture/acupressure points along pathway can also be provided. In keeping with standard practices of mind-body medicine, it is believed that meditation and visualization of the desired healing power of the liquid light by the end user would further support the beneficial effect on the energy field of the user.

### Sentimented Transforming Candles

In another application, color-changing or pattern-forming transforming candles in accordance with the present invention can be used to encourage and synchronize mental and spiritual focus on a particular desired outcome among many people, including those who are separated by great geographical distances. For example, a color-changing container candle can be distributed and used as a symbol of hope, compassion, and unified support for others, such as people in an area of the world who are rebuilding their lives after the occurrence of a natural or manmade disaster, or people who are adversely affected by war, political upheaval, or other devastating events in their lives.

As used herein, the term “sentimented” is meant to describe a candle that is made by a chandler who is experienced in practicing mindfulness, i.e., one who is trained in spiritual practices and is purposefully working with a clear intention to add to the wellbeing and greater good of all humanity through his or her thoughts, words, feelings (sentiments) and deeds. During all stages of the handling and mixing of the waxes and pouring of sentimented candles, the environment and the very work of the chandler are considered sacred. The attention of the chandler is focused on the present moment, and on a prayerful, benevolent intention to incorporate his or her positive energies and benevolent intentions into the liquid wax. Typical benevolent intentions include, but are not limited to: compassion, forgiveness, desire for world peace and understanding, desire for healing of people, animals, and/or the environment, desire for manifestation of the greatest good for all, and so on.

All stages in the handling and packaging of a sentimented candle are similarly conducted in a reverent manner. It would be redundant to use the term “positively sentimented” in this context because the intention of a chandler to include any form of negative energy or sentiment into a candle would fail, and would be meaningless.

The combination of a meaningful pairing or grouping of colors, along with a stated intention to incorporate particular sentiments and intentions into the candle, and to impart and share that intention with the end user, can be used as a powerful and symbolic expression of group support, “a prayer in a candle,” that contributes tangibly to an atmosphere of community spirit at times when others may feel unsupported, lacking in power, and alone. Additionally, all or a portion of the proceeds from the purchase of a sentimented candle can be tied to a charitable donation made to a benevolent organization that provides assistance to those in need. In this way, the end user of the sentimented candle contributes both energetic support to others (adding his or her own benevolent intentions and attention to their situation), but also to financial support of those in need.

The design considerations and qualities of a particular example of a sentimented color-changing container candle for promoting coordinated spiritual focus are described in Example 9 below. Using the methods described in the Example, this particular embodiment of a sentimented candle, termed the Rising Sun candle, was made in support of those seeking to rebuild their lives in the aftermath of the earthquake and resultant tsunami that affected Japan on Mar. 11, 2011.

In addition to enjoying their beauty, it is anticipated that many people will find various embodiments of transforming container candles in accordance with the present invention to be useful as convenient, portable tools for achieving relaxation, therapeutic color healing, and desired meditative states in a wide variety of settings.

### EXAMPLES

### Example 1

### Method of Making a Color-Changing Transforming Container Candle

All-natural soy wax pellets with a melting point of 110° F. (EcoSoya CB-Advanced, Nature's Gift International, Knoxville, Tenn.) were melted in an aluminum pouring pot placed in a water bath heated on a burner, and mixed with colored wax dyes to produce colored molten soy wax. A variety of colored waxes was prepared, including waxes in each of the “rainbow colors” (i.e., Red, Orange, Yellow, Green, Blue, Indigo, and Violet), as well as other colors including Pink, Red-Orange (Coral), Magenta, Olive Green, and Turquoise. In the case of the rainbow colors, wax colors were prepared to match the corresponding color on a standard pocket color wheel (The Color Wheel Company, Philomath, OR) showing primary (Red, Yellow, Blue), secondary (Green, Orange, Violet), and tertiary (e.g., Indigo, also known as “Royal Blue”) colors.

Tealight candles were prepared according to procedures described above and generally known in the art by pouring the molten wax into cylindrical clear polystyrene tealight candle containers, with an inner diameter of approximately 36 mm and an inside depth, from bottom to top, of about 16 mm.

Bilayered Container Candles. Six different colored waxes, prepared as described above, were made and dyed with dye chips comprising 100% natural vegetable and plant dyes (Candle Cocoon, Madison, Wis.), to achieve the following colors—Red, Orange, Yellow, Green, Blue, or Violet. To prepare bilayered color-changing candles, groups of clear plastic tealight candle containers were placed on a level, flat surface and carefully filled to approximately the midline of the container with wax of a first color (one of the six colors listed above). After the lower colored layers were poured, pre-tabbed coreless wicks suitable for tealight candles (e.g., Heinz Stabilo CD-3 (Technical Braiding, Nettetal, Germany) or TL-28 or TL-31 (Wedo, Nettetal, Germany) with a 15 or 20 mm metal base) were positioned in the center of the containers while the lower wax layer was still molten. The lower layers of colored waxes were allowed to cool and solidify at room temperature on a level surface.

After the lower wax layers had solidified, an upper layer of wax of a second color, different from the first, was poured over the solidified lower wax layer of each candle, filling the container nearly to the brim. The top layer of wax was allowed to cool and solidify as before. After cooling, the wax in the bilayered tealight container candles, viewed from the side, could be seen to comprise two distinct horizontal layers with no space between them—a lower layer of a first-colored wax and an upper layer of a second-colored wax, with both layers measuring approximately 8-9 mm in depth as measured from the side. The typical appearance of a bilayered tealight candle in accordance with the present invention is shown in FIG. 1A.

In this manner, bilayered candles were produced in each of the 30 possible combinations of two-colored candles that can be made from colored wax having the primary colors Red, Yellow, and Blue and the secondary colors Green, Orange, and Violet, arranged with each color positioned either as the bottom or the top layer of a bilayered candle. Additional bilayered candles were also produced in other color combinations such as Pink/Turquoise, Pink/Orange, and Olive/Magenta. (Note that as used in the present specification including tables, the designation “Color 1/Color 2” refers to a color combination in a bilayered candle in which the upper layer of the candle is made of wax having Color 1, and the lower layer of the candle is made of wax having Color 2.) Additionally, various bilayered combinations were made using colored wax in one layer and uncolored wax (which appears white or creamy white when solid and clear and nearly colorless when liquid) in the other layer.

Multilayered Container Candles. Several embodiments of color-changing candles in accordance with the present invention were made comprising a plurality of wax layers of different colors. To produce a “rainbow” container candle, a plurality of layers of colored wax was used, with each layer being poured successively over the previous layer. A cooling and solidifying step on a level surface was added between each addition of a colored wax layer, to prevent melting and distortion of the layer below and bleeding of the colors between the wax layers. A tabbed wick was placed in the container after the first layer of wax was poured.

In the case of a rainbow container candle configured as a tealight candle, in view of the size constraints of a standard tealight container, the volume of each colored wax layer for a six- or seven-layered tealight candle is limited to between about 2.0 and 2.5 ml of liquid wax.

In one non-limiting configuration, a seven-layered rainbow candle designated the “Candle of Hope” was produced using all-natural soy waxes prepared as described above, and wicked with all-cotton wicks coated with soy wax. The candle was made by layering seven colored soy waxes having the same colors and stacking order as occur in a natural rainbow. Thus, the Candle of Hope embodiment was made by pouring into a tealight candle container a lower first layer of a Red-colored wax, followed in order by successive layers of Orange, Yellow, Green, Blue, and Indigo-colored wax, and finally a top layer of Violet-colored wax. Viewed from the side, the solidified, unlit Candle of Hope tealight candle exhibited seven distinct colored layers of wax, with no perceptible space between them, arranged in the colors of the rainbow (FIG. 2A). A second embodiment was made using colors in the reverse order. Each of the colored layers in the rainbow tealight candles had a depth of approximately 2.0-2.5 mm.

### Example 2

### Burn Characteristics of Bilayered Color-Changing Soy Wax Candles

All bilayered tealight candles made as described in Example 1 were allowed to solidify for at least 4-6 hours, and typically for one or more days after pouring, and then subjected to burn testing to observe their characteristics.

Burn test methods. Bilayered tealight candles were made as described in Example 1 using soy waxes colored with dyes to create colored waxes having either a primary color (Red, Yellow, and Blue) or a secondary color (Green, Orange, and Violet). For consistency between batches, the color of each wax was adjusted to match the corresponding color shown on a standard color wheel. Bilayered candles were configured in each of the 30 possible color combinations using these six colored waxes.

Candles to be compared were placed in 5-position clear glass tealight holders and observed in groups of 5 or 10. The candles were lit at time zero, and observations were made continuously during burning. Photographs were taken at 15-20 minute intervals until the candle wax became completely liquid and the wax colors were fully mixed (typically 1-1.5 hours). Subsequently, the test candles were extinguished and the wax was allowed to solidify. The color characteristics of the cooled, solidified waxes were then recorded. In a subsequent burn test, the colors of the liquid waxes were once again observed and photographed. Whenever possible, the colors as observed were ascribed with reference to the standard color wheel that was used during preparation of the primary and secondary colors of the original six colored waxes.

Observations. Striking color changes were observed during burn tests of the 30 bilayered candle samples. As described in further detail below, for each color combination of the bilayered test candles, the burning characteristics and color change patterns were unique, visually appealing, and quite reproducible. However, regardless of the particular color combination, or the relative position of a color in the bilayer (i.e., upper or lower), certain characteristics applied to all bilayered and multi-layered candles, which will now be described.

For all colored candles, the duration of the melting times of the upper and lower layers of colored soy wax was approximately the same. Thus, in general, within approximately 5-10 minutes after lighting the wick, the wax on the entire upper surface of the candle became liquid, from the central area around the wick right to the periphery of the container. The appearance of the colored wax when molten presented a striking appearance. When liquefied, the colored soy wax appeared transparent, shiny and reflective, taking on a rich, jewel-like tone that was deeper in color and far more intense than the color of the corresponding wax when solid.

Initially the depth of the molten layer on the surface was only about 1-2 mm, but this depth gradually increased, and the corresponding depth of the solid portion of the top layer gradually decreased as the candle continued to burn. Within the first 30-40 minutes, the entire top layer of the candle became completely molten, whereas the bottom layer remained solid. During the next 30 minutes, the depth of the lower, solid layer gradually became reduced (from a maximum of about 9 mm to a minimum of about 1 mm before completely disappearing). After about 60-90 minutes of burning, the wax in the entire tealight candle was completely molten, at which time all evidence of the presence of the former bilayered construction of the wax layers was completely lacking. After complete disappearance of the solid wax at the bottom of the lower layer, the colored candle wax was transparent, taking on the appearance of colored “liquid light.”

Depending on the dye, the total burn times for these soy wax-based candles ranged from about 6-9 hours. Thus, for the majority of their burning time, the wax in the candles appeared as a clear liquid of a uniform color. As described below (see in particular Table 1), the final color of the liquid wax was determined by the combination of the two colors of wax originally comprising the upper and lower layers of the bilayered candle, which became fully mixed as the candle burned.

FIG. 1A-1F is a series of photographs depicting some of the changes observable during the burning of a color-changing bilayered candle in accordance with the present invention. More specifically, FIG. 1 is a black-and-white reproduction of a composite of six color photographs showing the color transformation of a Blue/Yellow bilayer candle during burning. The color changes, which are of course more appreciable when viewing the actual colored photographs, are described in words herein.

In the solid state seen before lighting the wick (FIG. 1A), the candle exhibited two layers of solid wax of approximately equal volume—a top wax layer that was Medium Blue in color, and a bottom wax layer that was Medium Yellow in color, with a clear boundary visible between the two layers. The surface of the solidified wax had a smooth appearance with a matte finish.

FIG. 1B shows the appearance of the Blue/Yellow bilayered tealight candle 15 minutes after lighting. The candle is shown resting in a depression in a 5-position glass tealight candle holder used to support the candles during the burn tests. At the 15 minute time point, the upper layer was molten to a depth of several millimeters, and was seen as a clear reflective liquid layer that presented a uniform color, i.e., Deep Blue. The bottom layer of the bilayer candle at that time was still solid wax, and colored Medium Yellow. By the 30-minute time point, the color of the top layer was changing markedly. Seen from above, this layer was still a shade of deep blue, but with a clearly detectable green tinge, which was unevenly distributed through the blue (FIG. 1C; streaks of green color are evident among the blue in the color photo corresponding to this image). After 60 minutes of burning, all of the wax in the lower layer was molten, and the wax was transparent throughout the candle (as evidenced, e.g., by the visibility of markings on the bottom of the tealight container, which can be seen in FIG. 1D through the transparent liquid wax). At this time, the color of all of the liquid wax in the Blue/Yellow bilayer candle was an attractive Deep Blue-Green (a tertiary color) that was very distinct from the Deep Blue (a primary color) originally seen in the upper layer after 15 minutes of burning (FIG. 1D). Thus, during burning, the bilayered candle completely changed its color—as seen from above, it first appeared uniform Deep Blue at 15 minutes, but was transformed by the flame into a candle that appeared uniform Deep Blue-Green after 60 minutes of burning.

At the 90 minute point, the flame was extinguished, and the candle wax in the Blue/Yellow bilayer candle was allowed to cool and solidify. FIG. 1E shows the appearance of this candle after cooling. When solidified, the wax in the candle that had been burned for 90 minutes presented a very uniform appearance. The entire tealight container was now filled with a single layer of wax of one color, in this case, a Pale Blue-Green shade (FIG. 1E). The color of the wax was almost completely uniform, with just a few tiny streaks of Yellow visible here and there in the Pale Blue-Green wax. Thus, the wax in the two colored layers of the formerly bilayered candle was transformed under the power of the flame into a monolayer of wax having a completely different, third color.

Upon re-lighting of the “former” Blue/Yellow bilayer candle, the color of the liquid wax in the wax monolayer of the color-transformed candle was the same shade (Deep Blue-Green) as observed at 60 minutes during the first burn of this Blue/Yellow bilayer candle.

Table 1 below summarizes the results of observations of the main color changes seen in the 30 tested combinations of bilayer candles comprising wax layers configured in the primary and secondary colors.

TABLE 1
Color Changes Observed During Burning of Bilayered Color-changing
Transforming Container Candles.

| Color Combination | Intermediate | Final Color | Final Color | |
|---|---|---|---|---|
| (Solid) | Color | (Fully Mixed, | (Fully Mixed, | Color on Second |
| Upper/Lower | (Liquid) | Liquid) | Solid) | Burning (Liquid) |
| RED/BLUE | Cherry Red | Deep Magenta | Med. Red-Violet | Deep Magenta |
| BLUE/RED | Wine | Deep Magenta | Med. Red-Violet | Deep Magenta |
| BLUE/YELLOW | Deep Blue-Green | Peacock Blue-Green | Med. Blue-Green | Peacock Blue-Green |
| YELLOW/BLUE | Dp. Yellow-Green | Peacock Blue-Green | Med. Blue-Green | Peacock Blue-Green |
| RED/YELLOW | Red | Red-Orange | Coral | Red-Orange |
| YELLOW/RED | Yellow-Orange | Red-Orange | Coral | Red-Orange |
| RED/ORANGE | Red | Deep Red-Orange | Deep Coral | Deep Red-Orange |
| ORANGE/RED | Orange-Red | Deep Red-Orange | Deep Coral | Deep Red-Orange |
| YELLOW/ORANGE | Yellow-Orange | Yellow-Orange | Lt Yellow-Orange | Yellow-Orange |
| ORANGE/YELLOW | Orange-Yellow | Yellow-Orange | Lt Yellow-Orange | Yellow-Orange |
| RED/VIOLET | Deep Red-Violet | Deep Red-Brown | Med. Red-Violet | Deep Red-Brown |
| VIOLET/RED | Deep Violet | Deep Red-Brown | Med. Red-Violet | Deep Red-Brown |
| BLUE/ORANGE | Deep Blue-Violet | Deep Olive Green | Med. Olive Green | Deep Olive Green |
| ORANGE/BLUE | Deep Copper | Deep Olive Green | Med. Olive Green | Deep Olive Green |
| RED/GREEN | Deep Red-Violet | Deep Burgundy Red | Med. Red-Violet | Deep Burgundy Red |
| GREEN/RED | Deep Violet | Deep Burgundy Red | Med. Red-Violet | Deep Burgundy Red |
| YELLOW/VIOLET | Mahogany Brown | Deep Red-Violet | Med. Violet | Deep Red-Violet |
| VIOLET/YELLOW | Deep Red-Brown | Deep Red-Violet | Med. Violet | Deep Red-Violet |
| GREEN/VIOLET | Deep Mahogany | Deep Violet | Med. Blue-Violet | Deep Violet |
| VIOLET/GREEN | Deep Red-Brown | Deep Violet | Med. Blue-Violet | Deep Violet |
| ORANGE/VIOLET | Dp Orange-Brown | Deep Magenta | Med. Violet | Deep Magenta |
| VIOLET/ORANGE | Deep Violet | Deep Magenta | Med. Violet | Deep Magenta |
| VIOLET/BLUE | Deep Violet | Deep Magenta | Med. Blue-Violet | Deep Magenta |
| BLUE/VIOLET | Deep Red-Brown | Deep Magenta | Med. Blue-Violet | Deep Magenta |
| ORANGE/GREEN | Copper | Golden Olive Green | Md. Yellow-Green | Golden Olive Green |
| GREEN/ORANGE | Deep Violet | Golden Olive Green | Md. Yellow-Green | Golden Olive Green |

Table 1 merely summarizes the main color changes that were observed at various times after lighting the two-color bilayered candles, whereas in fact the color changes seen in these candles represented a continuum. Because the flame is located at the level of the wick, which extends from the upper surface of the upper layer of wax, a tealight candle melts from the top downwards. It can be readily appreciated that as a result of the transformation of the candle wax from the solid to the liquid state, and the resultant mixing of the two colored waxes during the circulation of the wax through the lighted wick during burning, bilayered candles as described progress through many intermediate stages, during which the colors in the upper and lower layers are in the process of mixing.

As the upper wax layer melted during the first 15-30 minutes of observation of the tested bilayer candles, more and more of the color in the lower layer could be seen to enter the upper layer. Thus, the upper layer was seen to continually change color before one's eyes, even while all or a portion of the lower layer still appeared solid. For this reason, the bilayered candles presented an ever-changing series of color changes that was fascinating to watch. Unexpectedly, some of the color changes were not predictable. For example, it was unexpected to see the molten wax in a Blue/Orange bilayer candle transform in color first from Deep Blue to a Deep Blue-Violet color, and then to a golden Olive Green. Similarly, it was surprising and unexpected to witness the transition in color of the molten wax in an Orange/Violet bilayer candle from Orange to Deep Orange-Brown to a final shade of Deep Magenta.

Color changes in the upper layer were particularly amenable to observation in bilayer candles having an upper wax layer that was lighter in color than the lower layer, for in these, the introduction and mixing of the lower color into the upper color could be more readily appreciated. (For a description of other striking ways in which the dynamic flow of wax within a lit candle can be observed, see Examples 4 and 5 infra, describing pattern-forming transforming candles in accordance with the present invention.)

An example to illustrate the types of color variations observable in early stages of color change and mixing in a color-changing bilayered transforming container candle is provided e.g., by a comparison of the appearance of a pair consisting of a Yellow/Red and a Red/Yellow bilayer candle. When the two candles were first lit and compared side-to-side, within the first five minutes, the Yellow/Red candle exhibited a bright yellow layer of fluid wax on its surface, whereas the Red/Yellow candle exhibited'a bright red surface layer of molten wax. In fact, when viewed from directly above at this stage, the two candles appeared to be of completely different colors (i.e., Yellow and Red, respectively).

In the case of the Red/Yellow candle, over the next 30 minutes, the color of the top liquid layer of wax gradually and imperceptibly changed from Red (a primary color) to a Red-Orange (a tertiary color), presumably as the Yellow dye from the lower wax layer mixed with the Red dye of the upper wax layer. Without intending to be bound by any particular theory, the change in color of the top liquid layer of wax appeared to be mediated by the intermixing of the dyes contained in the two colored waxes as these waxes circulated through the wick and were redistributed within the confines of the tealight container.

In contrast to the gradual and imperceptible color transition from Red to Red-Orange observed in the Red/Yellow bilayer candle, the color changes were less uniform in the top liquid layer of the Yellow/Red candle. After 10-15 minutes of burning, the molten top layer of the Yellow/Red candle exhibited an attractive pattern consisting of streaks of Red color interspersed among the previously uniform Yellow-colored liquid wax. During this period of incomplete mixing of the colored waxes, the patterns of the streaks changed continuously with the ongoing flow of wax through the wick, until eventually the bottom wax layer was completely liquefied, and the two colors appeared to be uniformly mixed. At that time, the wax in the candle assumed its final color (i.e., Red-Orange, a tertiary color) which was different from that of either of the original two colors of wax, i.e., Red and Yellow.

The flame-driven phenomenon of mixing of the two colored waxes within pairs of bilayered candles sharing the same two colors (e.g., Red/Yellow and Yellow/Red) appeared to be quite complete, as evidenced by the fact that the same final color was reached, regardless of whether a particular color in the pair started out in the top or the bottom position in the candle. Thus, for example, for the above-mentioned Red/Yellow vs. Yellow/Red pair, despite differences in the appearance of the liquid upper layers before the mixing was complete, when fully molten and completely mixed after burning for approximately one hour, each of these candles displayed a visually homogeneous pool of liquid wax of a uniform color, i.e., Red-Orange. Similarly, after burning, the mixed wax in both of these candles exhibited the same uniform color upon cooling and solidifying (i.e., Medium Red-Orange, also known as Coral).

### Example 3

### Burn Characteristics of Multi-Layered Color-Changing Soy Wax Candles

This Example describes the changes in appearance observed during burning, cooling, and re-burning of a multi-layered “rainbow” embodiment of a color-changing transforming container candle of the invention.

Methods. Seven-layered “Candle of Hope” rainbow candles were made as described in Example 1 above. The seven-layered candles were configured using EcoSoya CB-Advanced soy wax colored with Flutterdyes solid wax dyes (Candle Cocoon, Madison, Wis.) to achieve the colors Red, Orange, Yellow, Green, Blue, Indigo and Violet. For consistency and ease in identifying colors and assigning color names, the colors of the waxes were adjusted to closely match the corresponding colors on a standard pocket color wheel, as described above.

To produce rainbow tealight candles, the colored waxes were melted and layered into clear acetate tealight containers as described above, in the following order: Red, Yellow, Orange, Green, Blue, Indigo, and Violet. After addition of the top layer of wax, the candles were allowed to cool and solidify for at least 4-6 hours after pouring, before being subjected to burn-testing. Sample candles were observed and photographed at various times during the burn tests, which were conducted essentially as described in Example 2 above.

Observations. In general, the burn-time characteristics of the 7-layered rainbow soy tealight candles were similar to those of the bilayered candles described in Example 2. Thus, the entire top surface layer of Violet-colored wax was seen to become liquid within 5-10 minutes of lighting the wick, and the underlying colored layers gradually became liquid one by one, culminating in the wax in the entire candle becoming liquid after about one hour of burning.

FIG. 2A-F is a series of photographs depicting some of the changes observable during the burning of a color-transforming 7-layer rainbow container candle in accordance with the present invention. Like FIG. 1A-F, FIG. 2A-F is a black-and-white representation of a composite of six color photographs showing stages in the transformation in the appearance and color of a color-changing candle of the invention. Unfortunately, details of the color changes that are readily discernable in the color photos are lost in the black-and-white images; nevertheless, the observed changes are accurately described in words herein.

Referring to FIG. 2A, and as described above, when viewed from the side in the solid state before burning, the wax in a rainbow candle presented a horizontally-striated appearance resembling a rainbow with Red color at the base and Violet color at the top. Although similar-appearing colors such as Yellow and Orange, and Blue and Indigo tended to blend together, upon close inspection, these colors could be seen as distinct layers within the rainbow candle.

FIG. 2B shows the appearance of a 7-layered rainbow tealight candle several minutes after lighting. In this photograph, the central portion of the upper, surface layer of Violet-colored wax is molten, whereas the wax around much of the periphery of the clear plastic tealight container is still solid at this point. As seen in the color photograph corresponding to FIG. 2B, the solid Violet-colored wax was Light Violet in color, whereas the molten portion of the Violet wax appeared as an intense Deep Violet shade (darker area seen on the candle surface in FIG. 2B). Within the first 10 minutes of burning, the entire upper surface of the rainbow candles was covered with liquid wax which gradually transformed in color from Deep Violet to Deep Violet-Blue.

As each layer of wax in the candles, from above downward, was transformed by the flame from the solid to the liquid state, the color of the liquefied top layer of wax was seen to undergo a striking series of color changes, some of which are shown in FIG. 2. FIG. 2C shows the appearance of a rainbow candle after the first 15 minutes of burning. Viewed from the side, five layers of colored solid wax were still visible from the bottom upward: the Red, Orange, Yellow, and Green layers, and a portion of the Blue. The upper molten layer at this stage was a Deep Blue color.

FIG. 2D shows a later stage, after about 30 minutes of burning, at which time approximately the upper half of the candle wax was molten and the only clearly discernable solid layers that remained were the Red, Orange and Yellow. The molten upper layer of wax was Deep Blue-Green at this time.

With the continued melting of the candle wax in the direction from above downward, the so-called “warm” colored (Yellow, Orange, and Red) solid wax layers began to disappear and their colors appeared to contribute to the ongoing color change in the molten top layer of the candles. At this time, the color of the top layer began to take on a reddish hue, which at 45 minutes was in striking contrast to the Deep Blue color previously seen in this layer. FIG. 2E depicts a rainbow candle at the stage of burning when only the Red layer of wax remained solid. At that time, the color of the upper liquid wax layer was between Brown and Red. With the continued melting of the Red layer, by 60 minutes of burn time, all of the wax in the rainbow candles was fully molten, and the liquid wax took on a very rich and attractive Deep Ruby Red/Magenta color (FIG. 2F).

Thus, powered by the flame, the upper, liquid layer of a color-transforming rainbow candle (which eventually came to include all of the wax in the candle) was transformed in color from Violet to Blue-Violet to Deep Blue to Brown-Red to Deep Ruby Red (Magenta) within the space of about one hour.

The rainbow candles were extinguished after approximately 90 minutes of burning and allowed to cool. After cooling, the solidified, mixed wax in these candles exhibited none of the former striated structure of the 7-layered candles. Instead, the wax appeared as a homogeneous, single layer having a Pale Brown color resembling that of milk chocolate.

Upon re-lighting, the wax in a “formerly 7-layered” rainbow candle, as soon as it was liquefied, assumed the same rich Deep Ruby/Magenta color that was seen previously around the 60 minute time point after the commencement of the first burning of the candle. The appearance of this jewel-like color, produced from the blending of the seven colors of the rainbow, was in fact quite surprising, given the unassuming Pale Brown color of the mixed wax in the solid state (which more reasonably would have been expected to simply appear dark brown when liquefied). An explanation for unexpected color change phenomenon was not sought in the present studies.

### Example 4

### Method of Making a Pattern-Forming Transforming Container Candle

This Example describes a method for making a gilded pattern-forming container candle that includes at least one layer of wax comprising a metallic dye.

Methods. Two ounces of EcoSoya CB-Advanced soy wax pellets (melting point 110° F.) were melted in an aluminum pour pot placed in a waterbath. A small fragment of a solid metallic gold dye for embellishing candle surfaces (Candles and Supplies, Quakertown, Pa.) was added to the wax in the pot and melted. The melted wax took on a deep rich metallic gold sheen, with no visible metallic particles, but with an obvious overall heterogeneity that was seen as a satiny, swirling pattern that changed when the mixture was stirred, giving the impression that the mixture contained two phases that were not completely miscible with one another. Similarly, a metallic silver wax with similar characteristics was prepared using a metallic silver-colored solid wax dye.

Some of the metallic golden wax was used to make golden wax tealight candles by pouring the golden wax into four standard clear acetate tealight containers. The remainder of the golden wax and the silver wax was used to create a layer of “glaze” on the surface of previously-made tealight candles of various colors: Magenta, Violet, Pale Pink, Black, and Peacock Blue. For glazing the surface of the previously-made candles, whatever volume of golden or silver wax that their containers could hold was poured onto the surface of the solid wax, to within about a millimeter of the top of the clear plastic containers. As used herein, the term “gilded” refers to a candle that has been glazed with a surface layer of a wax containing a metallic dye such as a metallic gold, silver, copper, etc. dye.

Results. When cooled and solidified, the golden gilded candles, and the gilded glaze on the upper surface of the colored candles, had a pale grayish-white appearance. Within this layer of uncolored wax, very fine particles with a metallic gold sheen, barely visible with the naked eye, were discernable. The golden particles were evenly distributed in a nearly complete layer on the surface of the candles, except in the wax that was within several millimeters of the edges of the tealight containers. The appearance of the silver gilded wax was similar to that of the gold, except for the silvery color of the metallic particles in the wax.

### Example 5

### Burn Characteristics of Gilded Pattern-Forming Container Candles

Gilded wax tealight candles and colored tealight candles glazed with a layer of golden or silver metallic wax, prepared as described in Example 4, were used in burn tests conducted essentially as described supra.

Most unexpectedly, once the candle wax became liquid, a remarkable “dance of the metallic pigments” began to be displayed on the surface of the gilded candles. It was found that the metallic particles, which appeared to be attracted to one another and which floated on the surface of the candle wax, served as markers for viewing the flow patterns within the liquid wax. Due to the presence of the metallic particles, it was seen that as the molten wax flowed out from the wick, it appeared to pour onto the surface of the candle, creating waves of molten wax that separated into two distinct phases—waves of gold or silver, and waves of colored candle wax that were free of metallic particles. At least some of the metallic component remained floating on the surface of the molten wax, forming intricate patterns on the surface of the wax pool.

FIG. 3A shows the appearance of a gilded pattern-forming tealight candle in accordance with an embodiment of the present invention, shortly after the candle was lit. The candle depicted in FIG. 3A was made according to the method described in Example 4 by pouring a thin layer of golden wax onto the surface of a deep blue-colored tealight candle and allowing it to harden. In the photograph shown in FIG. 3A, the layer of solidified gilded wax can be seen as the thin, lighter-colored layer on the surface of the candle. The beginning of a metallic pattern, reflecting the glow of the flame, can be seen in the pool of liquid wax that surrounds the lighted wick (FIG. 3A)

The nature of the metallic patterns formed on the candle surfaces were unique for each candle, and the patterns were dynamic and ever-changing while the candles burned. Some patterns were remarkably intricate, fine, and beautiful, e.g., resembling fanciful wings, eyes, fans, as well as streaks and stripes. The whole process of pattern formation was very pleasing to behold, and captivating to watch as it progressed. A representative selection of some of the patterns formed by the gilded pattern-forming candles is presented in FIGS. 3B-E. Each of these photographs depicts a different candle. The candles in FIGS. 3B, 3C, 3E, and 3F were photographed while placed inside glass holders for tealight candles.

It was observed that the gold- or silver-gilded candles did not burn with a tall flame, unlike an ungilded tealight candle of the same color made from the same wax and containing the same wick. Instead, the flame was lower and closer to the base of the wick, with a noticeable blue core. The temperature of the flame was apparently lower as well, because the time required for complete melting of the candle wax was extended, relative to that of unglazed candles. This reduced burn rate in the gilded candles was found to be advantageous for observing the patterns formed on the surfaces of these candles. For example, if one stares for an extended period at the flame of a normal tealight candle, a distracting afterimage of the flame is perceived on the retina, due to the intensity of the light emitted by the flame. By contrast, it was completely comfortable to stare indefinitely at the low flame created by the gilded pattern-forming candles. This was especially advantageous because it enabled extended viewing of the beautiful swirling patterns created by the floating metallic component as it was redistributed on the surface of the molten wax of the burning candle.

Yet another advantageous feature of a gilded pattern-forming container candle in accordance with the present invention is its “self-gilding” feature. As any tealight candle burns, the level of the wax gradually decreases, until all of the wax has been consumed after 6-12 hours (depending on the particulars of the candle wax and the wick), leaving an essentially empty tealight container and a burned wick mounted in a metal base.

In the case of the gilded tealight candles of the invention, it was observed that over a period of several hours of burning, the floating metallic component gradually disappeared. Unexpectedly, it was discovered that as the volume of the molten wax layer slowly decreased, the retreating front of liquid wax left behind a thin gilded coating on the inside surface of the tealight container above the level of the wax. This “self-gilding” feature resulted in a remarkably uniform thin metallic coating resembling gold or silver “leaf” or “foil,” which created a pleasing metallic accent around the inside rim of the candle container, which was further highlighted by the flame as the candle burned. FIG. 3F is a photograph of a golden gilded candle, which initially resembled the candle shown in FIG. 3A, after it had burned for about four hours. At that time, the volume of the liquid wax had been reduced by about half, and the upper portion of the clear plastic container above the level of the wax, which normally would appear transparent, displayed the characteristic coating of gold leaf produced by the self-gilding process described above.

### Example 6

### Effect of Observing Burning Colored Soy Tealight Candles on the Human Aura Color and Chakra Energies

This Example describes the results of preliminary studies on the effect on the colors of the human aura when observing colored liquid soy wax in lighted tealight candles, as measured using an automated system that correlates electrophysiological measurements taken from the hand with energy levels and aura colors.

Background. At the present time, there is a substantial and growing literature, primarily still in the lay and alternative medical press, supporting the concept of a “human energy system.” According to many ancient esoteric traditions as well as accounts of growing numbers of present-day clairvoyant individuals who claim an ability to “see” these energy fields around humans and animals, a human being is surrounded by a colorful, dynamic, constantly fluctuating electromagnetic field known as an “aura” or “biofield.” Electromagnetic vibrations, in frequencies ranging from about 200-1100 Hertz, have been recorded electrophysiologically under various laboratory conditions from electrodes placed on the skin of human subjects. Particular frequencies were shown to correlate with particular aura colors observed by clairvoyants (see, e.g., Valerie V. Hunt, Ph.D., Infinite Mind Science of the Human Vibrations of Consciousness, Malibu Publishing Co., Malibu, Calif., 1996). Based on studies conducted over many years at UCLA, Dr. Hunt determined that changes in the colors in the aura are associated with many physiological, and emotional and psychological states in human health and disease.

Based on these and other observations, color-based therapies are one of a cadre of new therapeutic approaches being investigated in the emerging alternative medical field known as “energy medicine” that aims to promote wellness and treat physical disorders by correcting imbalances within the human energy field. See, e.g., Donna Eden and David Feinstein, Ph.D., Energy Medicine. Balancing Your Body's Energies for Optimal Health, Joy, and Vitality, Penguin Books, New York, 2008; Jacob Lieberman, O.D., Ph.D., Light. Medicine of the Future, Bear & Co., Rochester, Vt., 1991; Joy Gardner, Vibrational Healing Through the Chakras with Light, Sound, Crystals and Aromatherapy, Crossing Press, New York, 2006. Color therapeutic approaches, using colored light of various wavelengths, are aimed at adding or counteracting a color in the body, in order to clear energy blockages and balance the energy in the meridians (energy pathways accessed by acupuncture) to obtain the optimal energy flow needed for wellness in the individual.

Other color-based therapeutic approaches involve simply imagining particular colors. For example, many meditative techniques are based on the ancient Eastern (Vedic) concept of chakras, which are visualized by clairvoyants as seven spinning colored energy centers distributed within the body from the base of the spine to the top of the head. Beneficial effects are claimed to result from visualizations such as imagining that one is “breathing in” a particular color and thereby enhancing the energy of the chakra of the corresponding color within the body. Such an approach has been promoted by respected Western-trained physicians including Deepak Chopra, MD, who is also schooled in the Vedic wisdom tradition.

Purpose. The studies described below were carried out to determine using objective criteria whether or not direct observation of a lighted colored “liquid light” candle in accordance with the present invention could affect the colors that are present in the aura of a human observer viewing the candles.

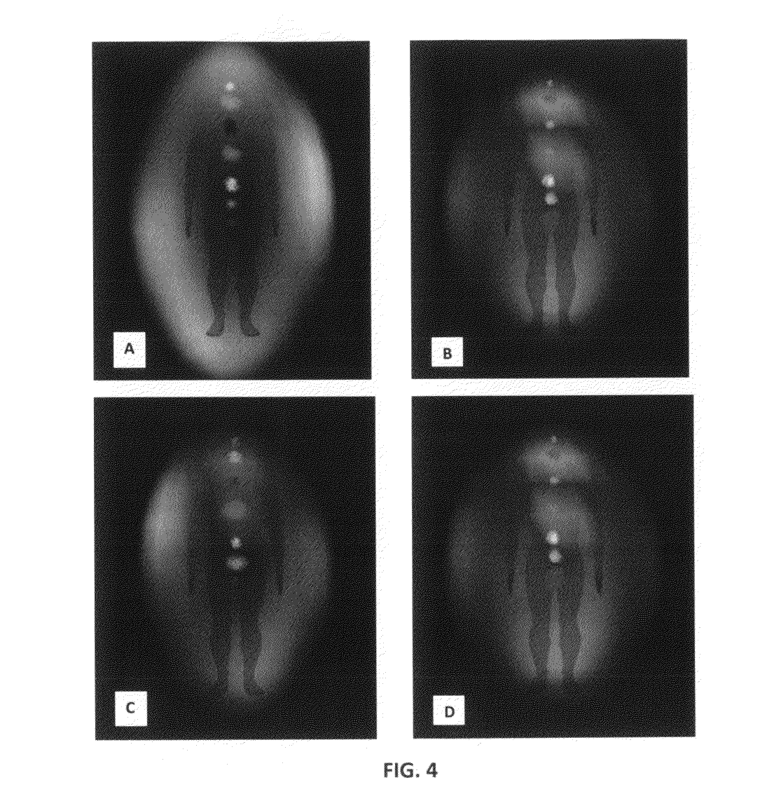

Methods. Human energy system measurements were taken using an AuraVideo Station (AVS) System (Inneractive Enterprises, Inc., Venice, Calif.). This system, which comprises a biosensor, webcam, computer, and software is configured to provide a variety of quantitative measurements, as well as real-time images representative of a subject's changing aura and chakra colors and shapes. Based on principles first described in the work of Valerie Hunt mentioned supra, the system takes measurements of galvanic skin response and temperature recorded in real time from a plurality of biosensors positioned on a console that is placed in contact with the left hand of the subject during data recording. Measurements of the detected electromagnetic frequencies are processed by the software in the system to produce, inter alia, a schematic image of an outline of a human body on which dynamic changes in the colors of the aura and seven in-body chakras are projected (FIG. 4).

FIG. 4 is a black-and-white reproduction of a composite photograph showing a series of aura-video images produced using the AVS equipment. Unfortunately, the differences in the aura colors in the four photographs do not reproduce well in the black-and-white reproductions presented here; however, the colors seen in the corresponding color images are described accurately in words herein.

All candle testing was carried out by commencing with a five-minute session during which the subject's energy parameters were observed and recorded under control conditions of dimmed lights, in order to establish normal baseline levels and to determine the extent of fluctuation of the baseline levels. Immediately following the baseline period, the subject was provided with a lighted red-colored soy tealight candle and instructed to clear the mind and focus all attention on the red candle for five minutes. At the end of the observation period, the subject's energy levels were tested again and recorded. In some experiments, the energy testing sequence (baseline test, then test with candle) was repeated using the same candle for a second or third time.

Results. Prior to commencement of the candle testing, the subject had exhibited a consistent baseline reading on the AVS System, which was confirmed repeatedly over a period of many days. In this subject, the baseline aura color was at the high end of the color spectrum (i.e., ranging from Blue-Indigo to Violet-White). A representative baseline aura-chakra image of the subject, taken immediately before testing with a red candle, is shown in FIG. 4A. The baseline aura color next to the body was Blue-Indigo and shades of light violet were seen in the periphery of the aura image.

A dramatic change in the aura color occurred in this subject after 5 minutes of observing a burning red tealight candle. The aura color close to the body changed from Blue-Indigo to bright Red, the lowest color on the spectrum (FIG. 4B). Colors seen in the peripheral areas of the aura included brilliant shades of Magenta, Orange, and Golden Yellow. These colors were never seen in the baseline aura of this subject. The change in the aura color as described was accompanied by marked quantitative changes in the recorded energy levels of the lower two, i.e., the first and second chakras (traditionally associated with the colors Red and Orange, respectively).

The profound and rapid change in the aura colors induced by observation of the red candle was found to be quite reproducible in this subject. FIGS. 4C and 4D show the results of a repeat test with the same red candle. At baseline, which was recorded four hours after the first exposure to the red candle, the subject's aura close to the body was again Blue-Indigo, with some Green and Blue-Green seen in the periphery (FIG. 4C). After five minutes of viewing of the burning red candle, the subject's aura again was seen to have changed to a brilliant Red, with the aura-chakra image (FIG. 4D) closely resembling that of FIG. 4B.

Similar results were obtained after the subject observed a Yellow soy wax tealight candle for five minutes. In this experiment, the subject's aura color changed dramatically from a baseline of Violet-White down to Yellow, which is at the lower end of the aura color spectrum.

Although preliminary, these striking results suggested that a subject can reproducibly change the color in his or her own aura and in energy levels in chakras related to the color of the introduced light, by observing a lighted colored tealight candle in accordance with the present invention. This observation is believed to have important implications and applications in the field of color therapy.

### Example 7

### Color-Changing Transforming Container Candles for Color Therapy of the Fourteen Meridians of the Human Energy System

Another aspect of the invention is a color-transforming container candle useful for modulating and balancing the energies of the meridians of the human energy system. As mentioned above, throughout history, people with the gift of clairvoyance and healing abilities have described the appearance of several components of the human energy system, including the aura, the in-body chakras and the meridians. The meridians have been extensively mapped, and the locations and medical significance of acupuncture points along the meridians are well known, forming the basis for energy manipulations practiced in Traditional Chinese Medicine.

This Example describes methods of making color-transforming container candles in accordance with the present invention that are useful for modulating and balancing the energies of the meridians recognized in Traditional Chinese Medicine, based on use of colored light delivered by the candles. As mentioned above, Donna Eden is a renowned and well-respected clairvoyant healer who is presently very active as an author and teacher in the field of energy medicine. Donna is able to see energetic patterns in humans and clear energy blockages and bring balance to the energies using various energy medicine methods which she has taught to thousands of people around the world. According to this author, in a DVD set and publication entitled Colors, Auras and the Psychic Realm, and a color chart included with this publication, one way in which the energy in each meridian may be manipulated and balanced is by the use of light of a particular color. In the Colors Auras method, a flashlight and a set of colored acetate sheets is used to shine light of a desired color over an acupuncture point associated with a meridian in need of treatment. The teachings of this author about colors of light useful for balancing, and for respectively increasing and decreasing the energy within a particular meridian, are listed in Table 2, infra.

Table 2 provides a summary of configurations of bilayer color-transforming container candles useful for supporting the energies of the 14 meridians as described in TCM, and as taught in modern references such as Eden et al., Energy Medicine, supra. Based on the Eden meridian color correlations, we describe herein color-transforming container candles in accordance with the present invention that are configured in color combinations useful for balancing the energies in the meridians. Using the eyes to perceive the colors, one can deliver liquid light in the appropriate colors into the energy field of the user, in support of the meridian in question.

For each meridian, there are two color combinations or “color pairs” shown in Table 2, one of which is the reverse of the other. The final color needed for energy balance in the meridian is the color indicated in column 3 of Table 2; this is the “balance” color that appears when the two layers of colored wax are fully mixed in the burning candle (typically after about one hour after lighting, for a soy-based tealight candle).

TABLE 2
Configurations of Color-transforming Container Candles Useful For
Modulating and Balancing Energies in the Meridians of the Human Energy System

| | | Final Color for | | |
|---|---|---|---|---|
| Candle Color | | Energy | | Daily Period of |
| Combination | Name of | Balance | Purpose of | Maximal |
| (Solid) | Meridian and | (Fully Mixed, | Candle Color | Energy in |
| Upper/Lower | Type | Liquid) | Combination | Meridian |
| PEACH or TERRA | STOMACH | Amber | Increase and | 7-9 AM |
| COTTA/ | Yang | | balance energy | |
| INDIGO BLUE | | | in the meridian | |
| INDIGO BLUE/ | STOMACH | Amber | Decrease and | 7-9 AM |
| PEACH or TERRA | Yang | | balance energy | |
| COTTA | | | in the meridian | |
| YELLOW/ | SPLEEN | Mahogany | Increase and | 9-11 AM |
| VIOLET | Yin | Brown | balance energy | |
| | | | in the meridian | |
| VIOLET/YELLOW | SPLEEN | Mahogany | Decrease and | 9-11 AM |
| | Yin | Brown | balance energy | |
| | | | in the meridian | |
| MAGENTA/PINK | HEART | Medium | Increase and | 11 AM-1 PM |
| | Yin | Magenta | balance energy | |
| | | | in the meridian | |
| ROSE/VIOLET | HEART | Violet-Magenta | Increase and | 11 AM-1 PM |
| | Yin | | balance energy | |
| | | | in the meridian | |
| YELLOW/VIOLET | SMALL | Mahogany | Increase and | 1 PM-3 PM |
| | INTESTINE | Brown | balance energy | |
| | Yang | | in the meridian | |
| VIOLET/YELLOW | SMALL | Mahogany | Decrease and | 1 PM-3 PM |
| | INTESTINE | Brown | balance energy | |
| | Yang | | in the meridian | |
| RED-ORANGE/ | URINARY | Russet | Increase and | 3 PM-5 PM |
| PURPLE | BLADDER | (Reddish | balance energy | |
| | Yang | Brown) | in the meridian | |
| PURPLE/ | URINARY | Russet | Decrease and | 3 PM-5 PM |
| RED-ORANGE | BLADDER | | balance energy | |
| | Yang | | in the meridian | |
| RED-ORANGE/ | KIDNEY | Russet | Increase and | 5 PM-7 PM |
| PURPLE | Yang | | balance energy | |
| | | | in the meridian | |
| PURPLE/ | KIDNEY | Russet | Decrease and | 5 PM-7 PM |
| RED-ORANGE | Yang | | balance energy | |
| | | | in the meridian | |
| RED-ORANGE/ | CIRCULATION- | Russet | Increase and | 7 PM-9 PM |
| PURPLE | SEX | | balance energy | |
| | Yin | | in the meridian | |
| PURPLE/ | CIRCULATION- | Russet | Decrease and | 7 PM-9 PM |
| RED-ORANGE | SEX | | balance energy | |
| | Yin | | in the meridian | |
| ORANGE/ | TRIPLE | Warm Brown | Increase and | 9 PM-11 PM |
| INDIGO BLUE | WARMER | | balance energy | |
| | Yang | | in the meridian | |
| INDIGO BLUE/ | TRIPLE | Warm Brown | Decrease and | 9 PM-11 PM |
| ORANGE | WARMER | | balance energy | |
| | Yang | | in the meridian | |
| MEDIUM | GALLBLADDER | Violet-Brown | Increase and | 11 PM-1 AM |
| YELLOW/ | Yang | | balance energy | |
| VIOLET | | | in the meridian | |
| VIOLET/ | GALLBLADDER | Violet-Brown | Decrease and | 11 PM-1 AM |
| MEDIUM | Yang | | balance energy | |
| YELLOW | | | in the meridian | |
| RED/BLUE | LIVER | Burgundy | Increase and | 1 AM-3 AM |
| | Yin | | balance energy | |
| | | | in the meridian | |
| BLUE/RED | LIVER | Burgundy | Decrease and | 1 AM-3 AM |
| | Yin | | balance energy | |
| | | | in the meridian | |
| ORANGE or | LUNG | Medium Warm | Increase and | 3 AM-5 AM |
| CRYSTAL | Yin | Brown or | balance energy | |
| (CLEAR)/ | | Medium Indigo | in the meridian | |
| INDIGO BLUE | | | | |
| INDIGO BLUE/ | LUNG | Medium Warm | Decrease and | 3 AM-5 AM |
| ORANGE or | Yin | Brown or | balance energy | |
| CRYSTAL | | Medium Indigo | in the meridian | |
| (CLEAR) | | | | |
| CRYSTAL | LARGE | Medium Violet | Increase and | 5 AM-7 AM |
| (CLEAR)/ | INTESTINE | or Purple | balance energy | |
| VIOLET or | Yang | | in the meridian | |
| PURPLE | | | | |
| VIOLET or | LARGE | Medium Violet | Decrease and | 5 AM-7 AM |
| PURPLE/ | INTESTINE | or Purple | balance energy | |
| CRYSTAL | Yang | | in the meridian | |
| (CLEAR) | | | | |
| LEMON | CENTRAL & | Lime Green | Balance energy | N/A |
| YELLOW/GREEN | GOVERNING | | in the meridian | |
| GREEN/LEMON | CENTRAL & | Lime Green | Balance energy | N/A |
| YELLOW | GOVERNING | | in the meridian | |

Bilayered soy tealight candles were prepared and burn-tested in all of the configurations shown in Table 2, and the final balance colors reached in the mixed wax are as shown in Column 3 of the table.

Referring to Table 2, it is seen that regardless of which color in the color pair is in the upper or lower position in the candle, the final color, representing the color of balance for the meridian, is always the same. However, depending upon the individual circumstances, in order to reach the desired balance of energy within the meridian, it may be appropriate to either stimulate (increase) the energy flowing in the meridian, or conversely, to sedate (decrease) the energy flowing in the meridian. Physical methods such as muscle testing for evaluating energetic flow in meridians, and “hands-on” methods for either sedating or stimulating energy in meridians and associated acupuncture or acupressure points are well known, for example in the healing arts Of acupuncture, therapeutic Massage, and energy medicine.

On the other hand, achieving the desired result of balancing meridian energies with the use of colored light alone has only recently been described. To our knowledge, no method has been described for using color to balance meridian energies in which a colored candle, or a color-changing transforming candle, is utilized to deliver light having the appropriate spectrum of colors. Accordingly, one aspect of the present invention is a candle-based method for balancing the energies in a meridian using a color-changing transforming candle configured with colored waxes that blend to create a final color suitable for balancing the energy of a given meridian. This approach has a notable advantage over the use of a light for shining through a colored filter onto an acupuncture point, in that it is more convenient and simpler to perform, and requires no special knowledge of the meridians. Furthermore, a continuous range of beneficial colors, as opposed to a single wavelength, is delivered as part of the treatment.

For example, referring to the first two rows of Table 2, it is seen that Amber light is the balancing color for the Stomach meridian. A bilayered tealight candle in accordance with the present invention can be made to burn with Amber light by using a combination of a layer of wax colored to burn Peach or Terra Cotta and a layer of wax colored to burn Indigo Blue. When fully mixed, the colors contributed by the dyes in the two wax layers combine, and the final candle color appears as Amber after about one hour of burn time.

It will be apparent that the final color for balancing the Stomach meridian can be achieved in two ways in a bilayered candle—i.e., by positioning the Peach/Terra Cotta layer above the Indigo, or vice versa, as shown in Table 2. However, the intermediate effects on the energies of the Stomach meridian that follow the burning of the two oppositely-configured candles in this illustrative example would be expected to differ. More specifically, for the first 10-15 minutes after lighting, the color in the molten upper layer of a candle with a Peach or Terra Cotta colored wax layer above initially appears Peach or Terra Cotta in color. As the candle burns, the color of the wax in the liquid layer gradually transitions into the color Amber (the balance color for the Stomach meridian), by virtue of the Indigo Blue layer becoming liquefied and gradually infusing its color into the Peach/Terra Cotta layer. Accordingly, an observier viewing this candle for an hour would receive an initial dose of Peach/Terra Cotta light (a color useful for increasing the energy in the Stomach meridian) prior to viewing the meridian-balancing Amber colored light. Furthermore, the meridian energy-boosting treatment color of Peach or Terra Cotta would continuously and progressively transition through countless intermediate shades before reaching Amber, the final color of balance. Thus, a Stomach meridian candle in this configuration can deliver both the energy-increasing color (Peach or Terra Cotta) and the energy-harmonizing or balancing color (Amber) in support of the energies of the Stomach meridian.

Conversely, in viewing a Stomach meridian candle made in the reverse configuration (i.e., with an Indigo Blue wax layer positioned over a Peach or Terra Cotta wax layer), for the first 10-15 minutes, the observer experiences a dose of Indigo Blue light (a color known to sedate or reduce the energies in the Stomach meridian). As the candle burns for the next 30-45 minutes, the color of the liquid wax layer gradually transitions through a range of shades of Blue-Browns as the Indigo Blue layer is infused with the color of the underlying Peach/Terra Cotta layer. Finally, upon complete mixing, the color of the liquid wax reaches the shade of Amber, the balance color for this meridian. Thus, a Stomach meridian candle made in this configuration can deliver both the energy-decreasing color (Indigo Blue) and the energy-harmonizing or balancing color (Amber) in support of the energies of the Stomach meridian. Similarly, Table 2 illustrates the color combinations and configurations useful in color-transforming container candles designed to support the energies of the other 13 described meridian pathways in the human energy system.

The meridian energy support candles as described can be self-administered by any competent adult without supervision. Given the reported daily 2-hour time period during which each meridian receives its maximal energy (Table 2) it is believed that viewing a candle configured to support and balance the energy of a particular meridian may be particularly effective at certain times of day. It is anticipated that the meridian candles may also find utility as an adjunct to other therapies received from a trained practitioner of acupuncture or other energy-based treatment modality.

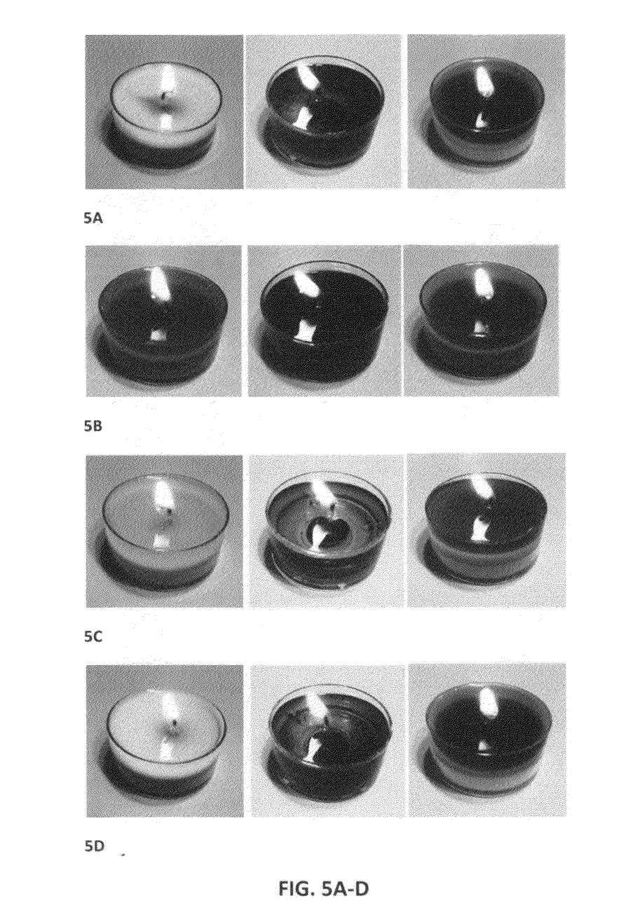

FIG. 5A-D is a black-and-white reproduction of a color photograph showing the representative appearance of four sets of bilayered color-changing container candles for modulating and balancing the energies in the meridians. In each case, the images in the panels on the left and on the right show the appearance of the burning candles approximately 10 minutes after being lit. The image in the center panel shows the appearance of the fully molten color-mixed candle, after approximately one hour of burning. The candles on the left and right are “reverse” embodiments of one another, as further described below, and the image of the candle in the center is representative of the fully-molten appearance of either of the left or right candles, because the blended color that appears after color mixing by the flame, (representing the balance color for the meridian), is the same for both embodiments.

More particularly, FIG. 5A depicts two “reverse” embodiments of a color-changing candle designed to modulate and balance the energies of the Gallbladder meridian. Both candles were made of soy wax configured in two layers of equal volume of wax, one colored to burn Medium Yellow and the other colored to burn Violet. The candle on the left is configured for increasing and balancing the energy in the meridian, as summarized above in Table 2. Accordingly, this candle, about 10 minutes after being lit and when viewed directly and seen in color photographs, shows a prominent layer of Medium Yellow liquid wax on top of a still-solid layer of Violet colored wax. Conversely, the candle depicted on the right side of FIG. 5A shows the reverse configuration, and is an example of a color-changing candle designed to decrease and balance the energies in the Gallbladder meridian. After about 10 minutes of burning, the surface layer of wax on this candle is Violet, and the still-solid base is Yellow. With continued burning, after about one hour, candles in both of the configurations shown in FIG. 5A, as seen in the middle photograph, exhibit a single layer of liquid wax in a shade of Violet-Brown, the balancing color of light for the Gallbladder meridian.

Similarly, reverse pairs of candles for modulating and balancing the energies of the Liver, Lung; and Large Intestine meridians, respectively, are shown after approximately 10 minutes of burning, and in their fully molten state, in FIG. 5B-D. More particularly, in accordance with Table 2, FIG. 5B shows a “reverse pair” of color-changing container candles configured with two wax layers in Blue and Red; FIG. 5C depicts a reverse pair of candles having Orange and Indigo Blue wax layers; and FIG. 5D shows a reverse pair of candles with Crystal (Clear) and Violet wax layers. The corresponding fully-molten appearances of each of these pairs of meridian candles are shown in the center images of FIG. 5A-D.

### Example 8

### Method of Making Color-changing Transforming Candles for Color Therapy of the Chakras of the Human Energy System

Whereas the meridians are energetic pathways that carry incoming energies into the energy field of the body and into particular organs and tissues associated with and supported by the meridians, the chakras are described as more complex energy-processing centers that not only receive energetic information accumulated in present time, but additionally have the capability to store and process energy received throughout the lifetime of the individual. Like the meridians, chakras are also associated with particular organs and systems within the body, and with particular colors, as indicated in Table 3, infra.

In many traditional accounts, it is stated that there are seven in-body chakras that are distributed in a column from the base of the spine to the crown of the head. As mentioned above, the chakras may be visualized by non-clairvoyant individuals, and their relative energies may be analyzed and recorded by means of a computerized system such as an aura-video system made by Inneractive (Venice, Calif.). Individual chakra energies, which are reportedly among the strongest of the so-called “subtle energies,” can also be easily sensed by energetically sensitive individuals, such as hands-on healers, by simply holding the flattened palm several inches over the corresponding body area and feeling the energy as a sensation in the hand.

We reported our observation above that observing liquid wax of a particular color such as Red or Yellow in a burning candle can change the color of the aura and the energies recorded in corresponding chakras (see Example 6). Visualization exercises in mind-body medical approaches suggest that there may be a therapeutic benefit to imagining a color that is believed to support the energies of each particular chakra. The candles of the invention offer a tangible opportunity to focus on one or more colors, by providing a single point of focus (a candle flame) that creates and illuminates liquid colored wax in the appropriate color or colors. The experience of the color can be enhanced by lowering the lighting, so that distracting images are eliminated and only the candle flame and the colored wax is visible.

The colors traditionally associated with the chakras are listed in column 2 of Table 3, infra, along with associated physical locations and structures within the body and corresponding spiritual relationships and associations.

TABLE 3
Major In-Body Chakras- Color of Light, Physical and Spiritual Associations

| | COLOR OF | PHYSICAL | SPIRITUAL |
|---|---|---|---|
| CHAKRA | LIGHT | ASSOCIATIONS | ASSOCIATIONS |
| 1. ROOT (BASE) | Red | At base of spine- pelvis, | Receiver of life energy, |
| | | vagina, male reproductive | basic issues of survival; |
| | | organs, legs and feet | sexual energy; tribal |
| | | | associations; area of |
| | | | stored traumas |
| 2. SACRAL | Orange | Top of pelvic bone to navel- | Creativity, imagination, |
| (WOMB) | | large and small intestine, | spontaneity, feelings of |
| | | uterus, ovaries, urinary | levity, joy, trust, and |
| | | bladder | freedom; “healing |
| | | | touch” ability in some |
| | | | people |
| 3. SOLAR | Yellow | Area between navel and | Individual identity, ego, |
| PLEXUS | | ribcage- liver, gallbladder, | personal power, self- |
| | | stomach, pancreas, spleen, | esteem; encoding of |
| | | kidneys and adrenal glands, | parental and societal |
| | | diaphragm | expectations, fear, logic, |
| | | | sense of being bound by |
| | | | responsibility |
| 4. HEART/THYMUS | Green or | Heart and circulatory system, | Compassion, hope, love |
| | Turquoise | pericardium, lungs, thymus, | of self and others; |
| | (“High Heart”) | breast, shoulder | universal love, |
| | | | giving/receiving; co- |
| | | | dependent sympathy |
| 5. THROAT | Blue | Throat, thyroid, | Seat of communication |
| | | parathyroids, neck, mouth | and expression; site of |
| | | | “energetic metabolism” |
| | | | (processor of energies |
| | | | and information input |
| | | | received from lower and |
| | | | upper chakras) |
| 6. THIRD EYE | Indigo Blue | Situated between the | Intuition, artistic ability, |
| | (Blue-Violet) | eyebrows at bridge of nose- | psychic abilities, mental |
| | | eyes, ears, nose, pituitary, | constructs |
| | | hypothalamus, pineal gland, | |
| | | most of brain | |
| 7. CROWN | Violet/White | Muscular system, skeletal | Spirituality; sense of |
| | | system, skin | life purpose, |
| | | | connectedness with |
| | | | realm of spirit |

Columns 1, 2 and 4 adapted from Deepak Chopra, Seven Laws of Spiritual Success and Inneractive Aura Video Station product description; Col. 3 adapted from Donna Eden et al. Energy Medicine and Caroline Myss, Anatomy of the Spirit, supra.

Although in some instances it may be beneficial to focus one's attention on the color of one chakra in isolation, many practitioners of energy medicine state that good health and wellbeing requires a flow of energy, free from blockages, from the Root chakra at the base of the spine to the Crown chakra at the top of the head. Thus, not only is it important for healthy levels of energy to flow within a given chakra, but it is also important for the energies of the chakras to flow smoothly from one to the next, forming a continuous column of energy that runs up the center of the body. Many successful healing techniques in energy medicine involve linking the energies of one chakra with those of another. For example, according to case studies reported in treatises such as Energy Medicine, a patient with an energetic blockage in the third chakra (manifesting physically as alcohol addiction and liver disease) can have damaged energies in the second chakra due to childhood trauma. Repair and restoration of the energies in the second chakra can free the second chakra energy to rise up to the level of the third chakra, enabling the patient to successfully overcome the alcohol addiction with conviction and renewed hope for a healthy and rewarding life. Similarly, linking the energies of the Solar Plexus (third) chakra to the loving energies of the Heart (fourth) chakra can enable a driven and fearful individual to begin to view the world and others more positively, and with less fear.

The present invention applies a color therapeutic approach to the goal of linking the energies of the one or more chakras, using “liquid light” candles as the means of delivering light of the appropriate colors. Accordingly, in one aspect, the invention provides a color-changing transforming container candle for supporting and linking the energies of two or more chakras. The candle can be configured as a multi-layered candle as described above, comprising two or more layers of wax of different colors that gradually blend as the candle burns. With seven in-body chakras and the seven colors listed in Table 3 (i.e., Red, Orange, Yellow, Green, Blue, Indigo Blue, Violet) it will be appreciated that there are 42 possible two-color combinations that can be made in a bilayered candle, and a total of 84 such combinations when taking into account the placement of each colored wax layer (either above or below) within the candle container.

As an alternative to making a candle in a bilayered configuration, a color-changing candle in accordance with the present invention, regardless of its intended purpose, can be configured to include a central core or column of wax comprising wax of a first color, and one or more outer rings or columns comprising wax of a second color, surrounding the core. The core or column for such a candle can be made by surrounding a pre-tabbed wick with a removable mold, into which wax of a first color is poured and allowed to solidify around the wick. The mold can be configured in any suitable shape and size to fit the interior of the candle container. To make a cylindrical core for a tealight candle, for example, one type of simple mold can be fashioned from a plastic drinking straw, which is positioned like a sleeve over a tabbed wick. Liquid wax is poured into the straw to a desired level, and allowed to harden around the wick.

After removal of the mold, the tabbed wick, surrounded by the central core of solidified colored wax of a first color, can be placed in a candle container such as a tealight candle cup. One or more layers of liquefied wax of a second color, or additional colors, can be poured around the wick with its colored wax core, with attention to controlling the temperature of the liquid wax to below the point at which it could cause the wax in the solid inner core to melt.

Two-color “colored core” transforming container candles were made in the manner described above using tealight containers, and burn-tested to observe their color-mixing and color-changing qualities. It was seen that as the wax in the candle became liquefied (from top down, as always), the wax in the core and in the surrounding wax layer appeared to melt simultaneously, and the color imparted by central core quickly blended in with the overall color of the entire layer of molten wax. At any given time during the burning of the candle, up to the time of complete liquefication of the wax throughout the candle, the color of the wax at the core could still be distinguished at the interface between the liquid and the solid wax.

As described above, in a two-color bilayered candle configured with an upper and lower layer of wax of two different colors, one observes a progressive and continuously changing gradient of color in the liquefied top layer of wax, as this layer is infused with the color from the wax in the lower layer. In contrast, in a “colored core” color-changing transforming candle as described herein, the first color, contained in the wax of the core, appears to continuously infuse its contribution into the second color of the surrounding wax. Thus, a candle of the “colored core” configuration can deliver a continuous dose of a desired, blended color throughout the duration of its burn time.

It is generally agreed that the energies of love and compassion associated with the heart chakra (Table 3) can provide balance to the energies of each of the other chakras (and vice versa in cases of an overactive Heart chakra, as exemplified in certain people who love others too much and take on others' pain to their own detriment). The color of light associated with the Heart chakra is Green. Accordingly, one particularly preferred embodiment of a color-changing transforming candle for linking the energies of two or more chakras in accordance with the present invention is a candle that links the Heart chakra energy with the energy of one or more of the other chakras. Candles for this purpose can be configured as bilayered or multi-layered embodiments comprising a layer of Green wax, or they can be configured with an inner core or column of Green wax, with one or more surrounding wax layers in a color suitable for strengthening the energy of another chakra.

In some embodiments of a color-changing transforming container candle for linking the energies of the Heart chakra with those of one or more other chakras, it may be preferable to replace the Green wax with wax that burns with a Turquoise (Green-Blue) color. Turquoise, a tertiary color, is the color traditionally associated with the “High Heart” chakra or “Chakra 4.5.” This chakra is reportedly concerned with love, compassion and communication on a global, rather than an individual, scale. The color Turquoise may be particularly appropriate in combination with colors such as Blue, Indigo, and Violet, which are believed to support the energies in the so-called “higher” chakras (fifth to seventh), which are concerned with processing energies related to mental, psychic and spiritual functions in the body and its energy field.

### Example 9

### Method of Making a Sentimented Color-Changing Container Candle in Support of People Following a Natural Disaster

As described above, a “sentimented” candle in accordance with the present invention is a candle that is made by a chandler who is practicing mindfulness while creating the candle, with the intention of incorporating the energy of his or her benevolent feelings (sentiments), thoughts and actions into the candle product. This Example describes artistic design considerations and methods used in the production of a symbolic sentimented candle that was inspired by feelings of compassion, empathy and desire to support the spirit of the Japanese people following the earthquake and tsunami experienced in March, 2011 in that country.

Design considerations for the sentimented candle. A two-color bilayered color-changing transforming container candle was conceived and designed, with the intention of including colors holding symbolic meaning for those affected by the disaster, as well as colors that would provide supportive energetic color vibrations. In the aftermath of a devastating natural disaster, people are focused on very basic issues of survival, and can feel an overwhelming sense of loss and powerlessness on many levels. Japan is known as the land of the Rising Sun, and the Japanese flag, as a symbol of this nation, depicts a prominent image of the Rising Sun in a bright shade of Red-Orange (Scarlet) against a white background. Hopeful images such as a rising sun with its rays can be a powerful and inspiring spiritual symbol representing rebirth, and a new day rising, especially under particularly challenging circumstances.

Thus, it was determined that the Red-Orange color of the Japanese flag would be a desirable final color of “liquid light” for the wax, after mixing of the two colored layers. The candle was reverently named the “Rising Sun” candle. Red-Orange is a tertiary color that is created by combining Red with Yellow, or Red with Orange. To make the Rising Sun candle, it was decided to use a combination of Deep Red below with Deep Yellow above, for energetic and symbolic reasons. Referring to the chakra association chart (Table 3), it is seen that Red is the color that is supportive of the energies of the Root or Base chakra, which are concerned, inter alia, with basic issues of survival and “tribal” or group identity. Yellow, the color that supports the Solar Plexus (third) chakra is the color that supports energies associated with one's sense of individual identity and personal power, as well as the energies of both courage and fear. Yellow is also a powerful, bright color symbolizing the sun at its most brilliant.

The combination of these two colors, as a bright symbol of hope, was chosen with the intention of symbolically recognizing and supporting the energies of survival (first chakra) and courage (third chakra) among Japanese people recovering from the earthquake. Further, the Yellow wax layer was positioned over the Red because the intermediate colors produced during the color transformation, which progress through many different shades of Yellow-Orange, Peach, and Orange, would be more appreciable in this configuration, as the darker Red wax infused its color into the Yellow. Advantageously, colors in the Orange family are supportive of the Sacral (second) chakra, a chakra associated with positive, childlike energies that fuel the imagination, and engender feelings of joy, trust, and freedom (feelings that may be in short supply in a disaster zone).

Production of sentimented candles. Bilayered color-changing transforming container candles were made from soy wax as previously described, using the symbolic concepts and particular color combination and configuration described above (Deep Yellow over Deep Red) while holding the intention of incorporating the positive energies of support, healing, and courage into the Rising Sun candle, and sharing these sentiments and energies with those of like-minded people.

Unexpectedly, it was discovered during the burning of candles made in this manner that the result was stunningly beautiful and even more symbolic than expected. As the Red infused its color into the upper layer of Yellow wax, a streaked appearance occurred in the upper layer of wax, with colors and patterns reminiscent of a brilliant and glorious sunrise! Thus, the changing colors and patterns in the molten upper layer of the candle seemed to further support the intention and purpose of the candle, by presenting an awe-inspiring display of healing “liquid light” resembling a beautiful sky at sunrise, graphically symbolizing the rising sun and the new day after the storm.

A further variation of the Rising Sun color-transforming container candle was made by applying a single spot of the Red wax, symbolizing the sun, on the surface of the solidified upper layer of Yellow wax. Shortly after the candle was lit, as the Red “sunspot” was transformed by the flame, it created localized swirling, changing patterns of Red within the surface layer of Yellow liquid wax, further adding to the beauty and appeal of the candle.

### INCORPORATION BY REFERENCE

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference, and may be employed in the practice of the invention. More generally, documents or references are cited in this text, either in a Reference List before the claims, or in the text itself; and each of these documents or references (“herein cited references”), as well as each document or reference cited in each of the herein cited references (including any manufacturer's specifications, instructions, etc.), is hereby expressly incorporated herein by reference.

What is claimed is:

1. A color-changing transforming container candle comprising:
a candle container;
a wick; and
at least a first layer and a second layer of a colored wax contained within said container and surrounding said wick, each of said wax layers being distinguishable from one another by their color, wherein the candle is configured such that during burning of the candle, each of said wax layers becomes liquefied, colored dyes in said colored wax layers are released and intermixed, and the candle wax is transformed into a single layer of a fully mixed wax having a final color that is different from the color of any of said at least first and second wax layers.

2. A color-changing transforming container candle according to claim 1, wherein the candle is configured to comprise a plurality of colored wax layers, between three and ten in number, each of said wax layers having a distinguishable color.

3. A color-changing transforming container candle according to claim 1, wherein the candle container is a cylindrical “tealight” candle container having a depth of about 19 mm and an inside diameter of about 38-40 mm.

4. A color-changing transforming container candle according to claim 2, wherein the plurality of colored wax layers includes wax layers colored Red, Orange, Yellow, Green, Blue, Indigo, and Violet, and the final color of the fully mixed wax is Magenta.

5. A color-changing transforming container candle according to claim 4, wherein seven colored wax layers are stacked in horizontal layers within the candle container, in the order seen in a rainbow (Red, Orange, Yellow, Green, Blue, Indigo, Violet), or in the reverse of this order.

6. A color-changing transforming container candle according to claim 1, wherein the wax is a soy-based wax with a melting temperature in the range of about 100° F. and 130° F.

7. A color-changing transforming container candle according to claim 3, wherein the tealight candle container is constructed of a clear, colorless plastic such as polystyrene.

8. A color-changing transforming container candle according to claim 1 useful for modulating and balancing the energies in a meridian of the human energy system, said candle comprising two or more colored wax layers that, when fully mixed, assume a final color in the liquid state that is known to balance the energies of the meridian.

9. A color-changing transforming container candle according to claim 8 useful for increasing and balancing the energy in a meridian, wherein the candle wax is arranged in a bilayered configuration, with an upper layer comprising a colored wax that when liquefied burns with a color known to increase the energies of the meridian, and a lower layer comprising a colored wax that when liquiefied and mixed with the liquid wax of the upper layer, results in wax of a final color known to balance the energy of the meridian.

10. A color-changing transforming container candle according to claim 8 useful for decreasing and balancing the energy in a meridian, wherein the candle wax is arranged in a bilayered configuration, with an upper layer comprising a colored wax that when liquefied burns with a color known to decrease the energies of the meridian, and a lower layer comprising a colored wax that when liquefied and mixed with the liquid wax of the upper layer, results in wax of a final color known to balance the energy of the meridian.

11. A color-changing transforming container candle according to claim 1 useful for balancing the energies in two or more chakras of the human energy system, said candle comprising two or more layers or inclusions of colored wax, each wax layer or inclusion being colored with a color associated with a chakra, wherein the candle waxes, when fully mixed, assume a final color in the liquid state that supports the energies of said chakras.

12. A color-changing transforming container candle according to claim 1, wherein the candle is configured to include a wax inclusion that forms a central core or column of colored wax of a first color that surrounds the wick, and one or more outer rings or columns of colored wax of a different color than that of the wax in the central core or column.

13. A color-changing transforming container candle according to claim 12 useful for linking the energies in two or more chakras of the human energy system, wherein the color of wax in the outer column of the candle, when liquefied, is selected to support a particular chakra in need of treatment and the color of wax in the core of the candle is selected to provide an infusion of the desired color, associated with the chakra to be linked, into the color of the chakra being treated.

14. A color-changing transforming container candle according to claim 13, useful for linking the energies of one or more chakras with the energies of the Heart chakra, wherein the color of the wax in the central core or column of the candle is either Green or Turquoise.

15. A pattern-forming transforming container candle comprising:
a candle container;
a wick; and
at least a first layer of a colored or uncolored wax, and at least a second layer, or a wax inclusion within the first wax layer, of a second colored or uncolored wax comprising particles that are insoluble in wax, said first and second waxes being contained within said container and surrounding said wick, wherein the candle is configured, upon burning of the wick, such that each of said first and second waxes becomes liquefied, and said particles are released from said second wax and can float and congregate on the surface of the molten candle wax, forming dynamic patterns as the candle burns.

16. A pattern-forming transforming container candle according to claim 15, wherein the wax of one or both layers or wax inclusions is a soy-based wax with a melting temperature of between about 100° F. and 130° F.

17. A pattern-forming transforming container candle according to claim 15, wherein the second wax comprises metallic particles that can form a gilded pattern on the surface of the burning candle.

18. A pattern-forming transforming container candle according to claim 17, wherein the metallic particles can further form a thin coating of metal foil or leaf on the inside surface of the container above the level of the wax as the candle burns.

19. A color-changing transforming container candle according to claim 1 that is useful as a timekeeper, wherein the volume of wax and the concentration of colored dye in said first and second layers is proportioned so as to result in a reproducible, visible color change in the candle in a specified time period after lighting of the candle.

20. A color-changing transforming container candle according to claim 1 that is sentimented with benevolent intentions directed to the candle during its production by a chandler who is practicing mindfulness.
